(19) United States
(12) Patent Application Publication
(10) Pub. No.: US 2010/0145801 A1
(43) Pub. Date: Jun. 10, 2010

(54) METHODS AND SYSTEMS FOR A TIME-AWARE OR CALENDAR-AWARE FACILITATOR TO IMPROVE UTILIZATION OF TIME-SENSITIVE OR PERISHABLE RESOURCES

(76) Inventor: Jagannadha Raju Chekuri, Pleasanton, CA (US)

Correspondence Address: SCHWEGMAN, LUNDBERG & WOESSNER, P.A., P.O. BOX 2938, MINNEAPOLIS, MN, 55402, US

(21) Appl. No.: 12/264,002

(22) Filed: Nov. 3, 2008

Related U.S. Application Data
(60) Provisional application No. 60/984,710, filed on Nov. 1, 2007.

(51) Int. Cl. G06Q 30/00; G06Q 20/00; G06Q 10/00; G06Q 50/00

(52) U.S. Cl. 705/14.51; 705/26; 705/307

(57) ABSTRACT

A first interface is provided to enable one or more suppliers to publish listings of available time-valued resources. Each of the available time-valued resources is associated with a predetermined time slot of availability. A second interface is provided to enable one or more consumers to publish listings of needed time-valued resources. Each of the needed time-valued resources is associated with a predetermined time slot of need. The first interface and the second interface are provided by a matching engine. A notification is generated when it is determined that a listing of an available time-valued resource matches with a listing of a needed time valued resource based on time information and calendar information.

### RELATED APPLICATION

This application claims the benefit of priority under 35 U.S.C. 119(e) to U.S. Provisional Patent Application Ser. No. 60/984,710, filed Nov. 1, 2007, which is incorporated herein by reference.

### FIELD

The invention generally relates to the field of computer networking, and more specifically but not limited to systems and methods that facilitate and implement a time-aware or calendar-aware matching service.

### BACKGROUND

A traditional online marketplace enables sellers to list their items or services for sale and then wait for a buyer to engage into a transaction. The items may be listed for a fixed time period. Potential buyers may use the online marketplace and the buyers may perform searches to locate desirable items. When a desirable item is available, the online marketplace may enable the buyer to purchase the item via an auction approach or a fixed price approach. A seller who is unable to sell an item during the fixed time period may relist for another fixed time period. Similarly, a buyer who is unable to find a desirable item may continue to search the online marketplace until one is found. In these circumstances the buyer actively enters keywords and performs the searching functionality.

### BRIEF DESCRIPTION OF THE FIGURES

FIG. 1 is a block diagram illustrating an example of a matching system, in accordance with some example embodiments.

FIG. 2 is a network diagram illustrating an example of a distributed network that may be used with a matching system, in accordance with some example embodiments.

FIG. 3 illustrates an example of an online calendar, in accordance with some example embodiments.

FIG. 4 illustrates an example of an online calendar that may be used by a supplier or a consumer, in accordance with some example embodiments.

FIG. 5 illustrates another example of an online calendar, in accordance with some example embodiments.

FIG. 6 illustrates another example of an online calendar, in accordance with some example embodiments.

FIG. 7 is a block diagram that illustrates a matching example with one agreement, in accordance with some example embodiments.

FIG. 8 is a block diagram that illustrates a matching example with multiple agreements, in accordance with some example embodiments.

FIG. 9 is a block diagram that illustrates a matching example with multiple consumers and one supplier, in accordance with some example embodiments.

FIG. 10 is a block diagram that illustrates a matching example with multiple suppliers and one consumer, in accordance with some example embodiments.

FIG. 11 is a block diagram that illustrates a matching example with multiple consumers and multiple suppliers, in accordance with some example embodiments.

FIG. 12 is a block diagram illustrating examples of modules that may be included in a matching engine, in accordance with some example embodiments.

FIGS. 13A and 13B illustrate examples of a data store module, in accordance with some example embodiments.

FIG. 14 illustrates an example of how a data store may be deployed on a global basis, in accordance with some example embodiments.

FIG. 15 illustrates an example of a more detailed view of a data access module, in accordance with some example embodiments.

FIG. 16 is a flow diagram illustrating an example of a process that may be used by a matching engine to identify a potential match, in accordance with some example embodiments.

FIG. 17 illustrates an example of how the suppliers can manage their resources and calendar in the matching engine, in accordance with some example embodiments.

FIG. 18 illustrates an example of how the consumers can manage their needs in the matching engine, in accordance with some example embodiments.

FIG. 19 a diagram that provides an example of how to perform a manual search in the matching engine, in accordance with some example embodiments.

FIG. 20 shows an example of how the automatic search may work in the matching engine, in accordance with some example embodiments.

FIG. 21 illustrates an example of how to match a consumer to suppliers and resources, in accordance with some example embodiments.

FIG. 22 illustrates an example of how to match a supplier to potential consumers with matching needs, in accordance with some example embodiments.

FIG. 23A illustrates an example for the objects representing the listing of a resource and the associated availability calendar, in accordance with some example embodiments.

FIG. 23B illustrates an example of objects representing the listing of a resource by a supplier or an offer to acquire a resource by a consumer within the marketplace, in accordance with some example embodiments.

FIG. 23C illustrates an example of objects that may be required for the marketplace to be fully operational, in accordance with some example embodiments.

FIG. 24 illustrates an example interface of the matching system listing the time-valued resources, in accordance with some example embodiments.

FIG. 25 illustrates an example map interface that may be used to search for Mos, in accordance with some example embodiments.

FIG. 26 illustrates an example of a calendar interface that may be used to display search results, in accordance with some embodiments.

FIG. 27 illustrates an example of a listing interface.

FIG. 28 illustrates an example of a booking interface.

FIG. 29 illustrates an example of a payment interface.

FIG. 30 illustrates an example of a confirmation interface.

FIG. 31 illustrates an example of an account summary interface.

FIG. 32 illustrates an example of a communication tool interface.

FIG. 33 illustrates an example of an interface that may be used to create a listing.

FIGS. 34A & 34B illustrate examples of an interface that may be used to describe a listing, in accordance with some embodiments.

FIG. 35 illustrates an example of a rate interface.

FIG. 36 illustrates an example of a publish interface.

FIG. 37 illustrates an interface that enables listing information to be reviewed and confirmed.

FIG. 38 illustrates an example of a social cause interface.

FIG. 39 illustrates an example of status interface.

FIG. 40 illustrates an example of a calendar.

FIG. 41 illustrates an interface that may be used to invite friends or anyone else to become a member of the matching system.

FIG. 42 illustrates an example of an online status interface that may enable a user to modify online status information.

FIG. 43A illustrates an example diagram of an avatar, in accordance with some example embodiments.

FIG. 43B illustrates an example of price surfing, in accordance with some example embodiments.

FIG. 44 is an example of a typical computer system upon which embodiments may be practiced.

### SUMMARY

Some example embodiments may include methods and systems to match a need or demand with a supply or provision of a time-valued resource in the context of a calendar. The calendar may display or identify the demand and availability (supply) of a resource. At least one match from a potential of multiple matches may be selected. The match may enable an increase in utility of a given time-valued resource by capturing a perishable time value of the time-valued resource and converting it into utility. The utility may be temporal. The utility may be compensated through monetary payment to a supplier of the time-valued resource. The utility may enable an increase in fulfillment of a consumer's needs by converting the perishable time value of a consumer into utility of the time-valued resource.

Some example embodiments may include methods and systems to implement a computer-based marketplace for time-valued resources. The time-valued resources may have perishable time-value. A match may be selected based on a calendar of availability and a calendar of needs, and wherein the match may be lead to an agreement. The agreement may be part of a transaction. The transaction may be managed through to completion. The agreement may enable the consumption or usage of the time-valued resources. Collection and payment of monies between a consumer and a supplier associated with a time-valued resource may be performed. An escrow account may be used as part of the collection and payment of monies.

Some example embodiments may include methods and systems to enhance value or benefit of time-valued resources by involving a large number of consumers and suppliers in a competitive marketplace that processes the time-valued resources as listings using a competitive bidding process. The marketplace may be aware of a calendar of availability associated with each supplier, and a calendar of needs associated with each consumer. Relevant confidence level information about the consumers and the suppliers participating in the marketplace may be collected and published for the purpose of creating increased competition and differentiation to enhance value of the timed-valued resources. Both the consumers and the suppliers may be able to adjust attributes associated with their listings to affect value and to promote their listings.

Some example embodiments may include methods and systems to enable consumers and suppliers to make a philanthropic donation as part of their engagement with a marketplace where time-valued resources are processed using time-aware or calendar-aware matching techniques. A participant in the marketplace, either as a consumer or as a supplier or both, may participate in social cause programs by making donations to one or more social causes as identified by the participant. The level of donation may be prominently included in the performance rating of the participant. The performance rating of a participant may allow potential consumers or suppliers to support the more philanthropic participants by preferring to engage with the more philanthropic participants. The social cause programs may be supported by the marketplace organizing company through its own support of social causes. The social causes may be established by the participants through independent donations driven by various external or internal marketing driven campaigns. Other example embodiments may also be described.

### DETAILED DESCRIPTION

For some example embodiments, methods for matching needs of time-valued resources by consumers with availability of time-valued resources from suppliers using a matching engine that is aware of both one or more consumer's calendar of needs and one or more supplier's calendar of availability are disclosed. Utilization of the time-valued resources may be enhanced for the benefits of the consumers and suppliers.

In the following detailed description, numerous specific details are set forth. However, it is understood that embodiments may be practiced without these specific details. In other instances, well-known circuits, structures, and techniques have not been shown in detail in order to not obscure the understanding of this description. These embodiments are described in sufficient detail to enable those of ordinary skill in the art to practice the example embodiments. The following detailed description is, therefore, not to be taken in a limiting sense, and the scope of the invention is defined only by the appended claims.

### I/ Introduction

For some example embodiments, matching systems that involve one or more consumers of one set of time-valued resources and one or more suppliers of another set of time-valued resources are disclosed. When a time-valued resource needed by a consumer is similar to a time-valued resource supplied by multiple suppliers, a competitive environment may be created. Similarly, when a time-valued resource available from a supplier is similar to a time-valued resource needed by multiple consumers, a competitive environment may be created. The environment may include one or more suppliers, one or more consumers, one or more time-valued resources, one or more time slots, or any combinations thereof.

In the following description, a time-valued resource may include a resource that may lose its opportunity for gain by a supplier or by a consumer during a period of time if not utilized or consumed. It may be said that the time-valued resource has perishable time value. A time-valued resource may be an intangible resource (e.g., service, skills, expertise, etc.), or a tangible resource (e.g., an automobile, hard goods, property, etc.), or combinations of both that may offer a value.

A supplier of a time-valued resource may be an owner, a seller, or one that manages or controls the time-valued resource. The supplier may control the availability of the time-valued resource. The supplier may supply one or more time-valued resources. Multiple suppliers may supply a similar time-valued resource or different time-valued resources to one or more consumers. The supplier of one time-valued resource may be a consumer of another time-valued resource.

When a time-valued resource from a supplier is not utilized, the supplier may miss an opportunity for gain. The missed opportunity may occur during any period of time when the time-valued resource is idle. The missed opportunity for gain by a supplier may or may not be monetary related.

A consumer of a time-valued resource may be a buyer, or one that needs or controls a need for a time-valued resource. A consumer may have a need for one or more time-valued resources. Multiple consumers may have needs for a similar time-valued resource or multiple different time-valued resources from one or more suppliers. A need for a time-valued resource from a consumer may be a requirement for the usage or consumption of the time-valued resource. The usage may take many forms, including, for example, renting a tangible item during a period of time, acquiring a skill during a period of time, etc. When there is a need for a time-valued resource during a period of time, and the need is not satisfied, a consumer may miss an opportunity for gain or satisfaction during that period of time. For example, a consumer may miss an opportunity to acquire knowledge, gain a skill, etc. The missed opportunity for usage, consumption or satisfaction by a consumer may or may not be monetary related.

A supplier or a consumer may be an individual, an organization, or any identifiable person or device that is capable of managing and controlling a time-valued resource. The supplier may be accountable for the supply of a time-valued resource. The consumer may be accountable for the usage of a time-valued resource.

### II/ Matching System

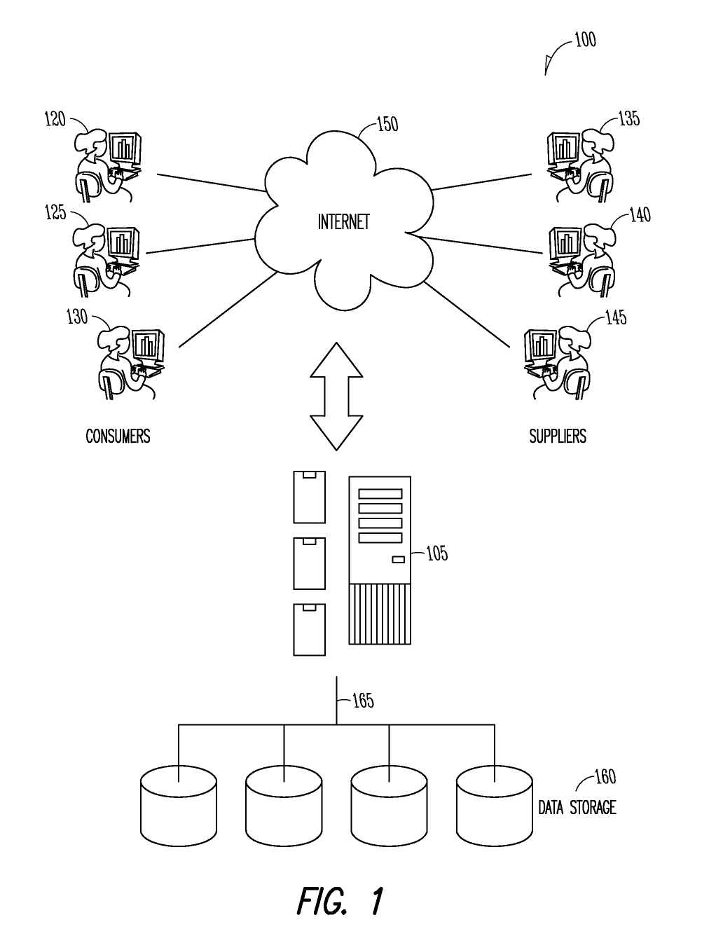

FIG. 1 is a block diagram illustrating an example of a matching system, in accordance with some example embodiments. Matching system 100 may include server computer system 105 (or a cluster of server computer systems 105). The server computer system 105 may operate with an operating system (OS), server software, communication software, and any other software and hardware suitable and known in the industry for a server computer system. The server computer system 105 may include software used by and/or to implement the matching system 100.

The matching system 100 may include multiple client computer systems 120-145. Each of the client computer systems 120-145 may include hardware and software to enable it to communicate with the server computer system 105. Each may operate with a Windows-based OS, a Unix-based OS, a Mac-based OS, or any other OS that may enable compatibility with the software and hardware configured on the server computer system 105. Browser software may be used to enable each of the client computer systems 120-145 to be connected to the Internet 150. The client computer systems 120-145 may be located in a similar geographic area or in various geographical areas. Any one of the client computer systems 120-145 may be a portable device or a non-portable device.

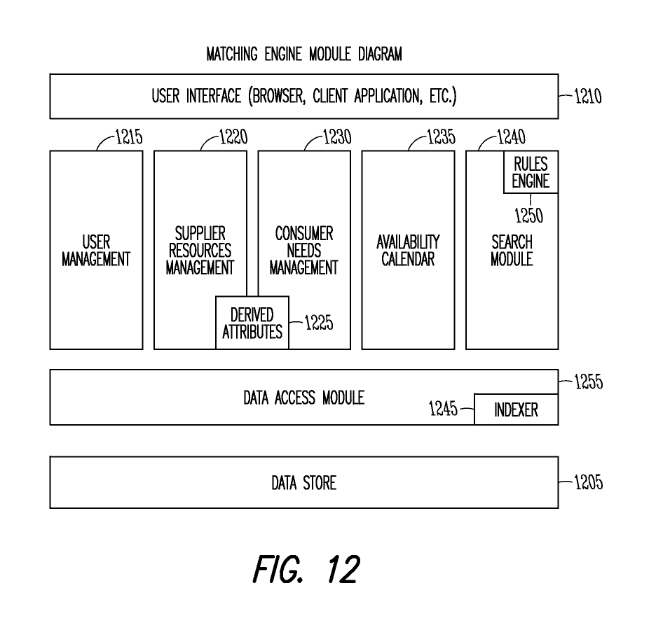

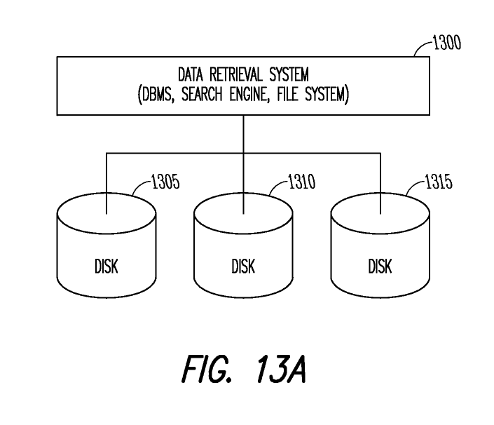

For some example embodiments, connection between any one of the client computer systems 120-145 and the Internet 150 may be a wired connection or a wireless connection. The connection to the Internet 150 may via an Internet service provider (ISP) using a corporate Internet connection, a dial-up modem connection, or any other connection techniques that may be known in the industry. For some example embodiments, connection between the server computer system 105 and the Internet 150 may be one or more high-speed/high-bandwidth connections using one or more ISPs. Examples of the server software are described in FIG. 12 (matching engine).

The server computer system 105 may be coupled to one or more storage devices 160. In this example, the storage devices 160 are illustrated as directly connected to the server computer systems 105; however, other embodiments of the matching system 100 may involve the storage devices 160 remotely connected to the server computer systems 105. When the storage devices 160 are remotely connected to the server computer system 105, the connection 165 may involve use of a Virtual Private Network (VPN) over a public network such as the Internet, or it may involve a dedicated connection over a leased private line. Other type of connections known in the industry may also be used. The storage devices 160 may include one or more databases managed by one or more database servers. The databases may be used to store information associated with the consumers, the suppliers, information about their time-valued resources, and information about calendar of availability and calendar of needs associated with the time-valued resources. Other information may also be stored in the databases.

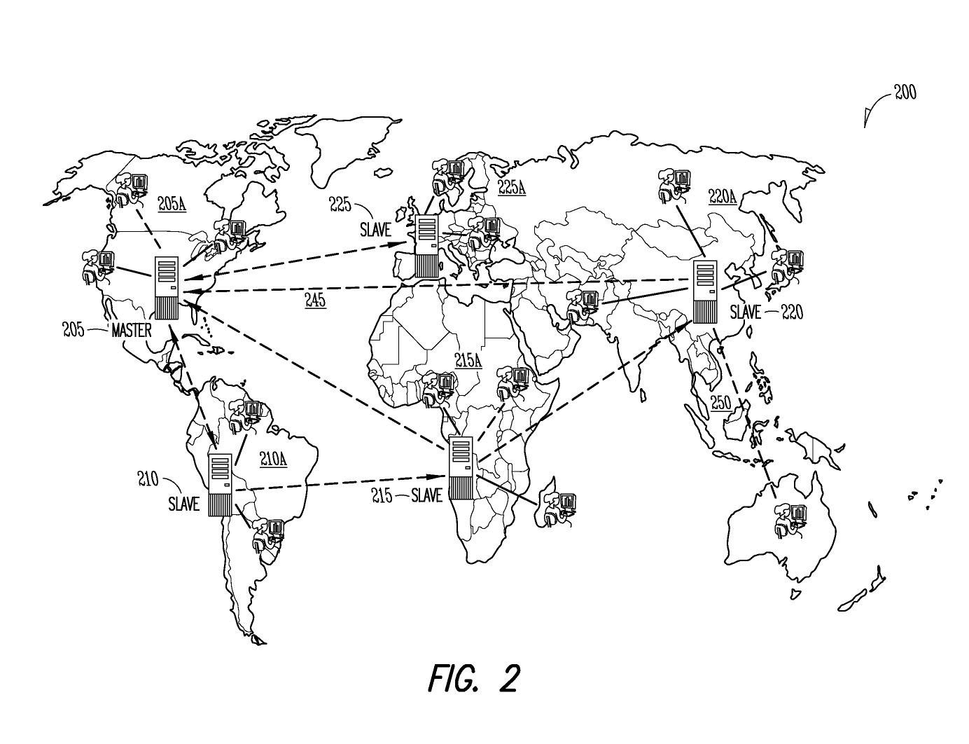

FIG. 2 is a network diagram illustrating an example of a distributed network that may be used with a matching system, in accordance with some example embodiments. Network 200 may include multiple server computer systems 205-225. The server computer systems 205-225 may be located in one geographical area, or they may be located in different geographical areas.

The connections from the server computer systems 205-225 may involve one or more high-speed connections with one or more ISPs in each of the geographical locations. For some example embodiments, there may be one master server computer system 205 and multiple slave server computer systems 210-225. The master server computer system 205 may control matching information on a global basis. The slave server computer systems 210-225 may store replicated matching information for various purposes including, for example, backup, improvements in processing speeds, etc. Matching information may flow from one slave server computer system to another slave server computer system or to the master server computer system 205. Communications among the server computer systems 205-225 may be illustrated in the current example as the dotted lines (e.g., line 245) connecting the various server computer systems.

Typically, the consumers and the suppliers in a geographical area are associated with a server computer system located in the same geographical area. This may vary depending on the amount of usage experienced in the various geographical areas. As the information traffic increases in a certain geographical area, additional slave server computer systems may be added. In the current example, there are multiple groups of users (consumers and/or suppliers) 205A-225A, each associated with one of the server computer systems 205-225.

It may be noted that, regardless of the association with a server computer system, the consumers and the suppliers from one geographical area may be able to enter into agreements with the consumers and the suppliers in various other geographical areas. Communications between the consumers and the suppliers in the groups of users 205A-225A and the server computer systems 205-225 may be illustrated in the current example as the solid lines (e.g., line 250) connecting the various server computer systems to the consumers and the suppliers via their client computer systems, such as those illustrated in the example in FIG. 1.

For some example embodiments, the matching system may be used to implement a marketplace which may facilitate a global community of suppliers and consumers to find potential matches. A potential match may need to be reviewed and approved by the associated consumer and supplier. The potential matches may be for exchange of intangible or tangible goods, within the context of a calendar of availability and a calendar of needs that is mutually agreeable between one or more suppliers and one or more consumers.

### III/ Resource Attributes

A time-valued resource may be associated with a set of attributes. The attributes may be used to describe the time-valued resource and may be used for the purpose of finding a potential match. Some examples of the attributes may include descriptive keywords, detailed descriptions, cost or value related information, use restrictions, need preference, information that may be useful for determining a potential match, etc.

The attributes may be modified by the consumer or the consumer's representative, by the supplier or the supplier's representative, or by the matching system based on certain criteria. Other attributes may also be used.

For some example embodiments, the attributes may be entered using an interface provided by the matching system. The interface may present questions related to the attributes to help the suppliers and the consumers enter the appropriate attribute information.

### IV/ Time Slots

A time slot may include a period of time when a time-valued resource is available or needed. For example, a time slot may be from 5 p.m. to 6 p.m. A time-valued resource may be associated with one time slot or multiple time slots. The multiple time slots may be periodic or scattered. For example, the period time slots may include time slots between 2 p.m. and 4 p.m. every day for five consecutive days. The scattered time slots may include a time slot from 6 p.m. to 7 p.m. on Monday and a time slot from 8 a.m. to 9 a.m. on Thursday. It may be possible for the matching system to identify a potential match on a single time slot or on multiple time slots.

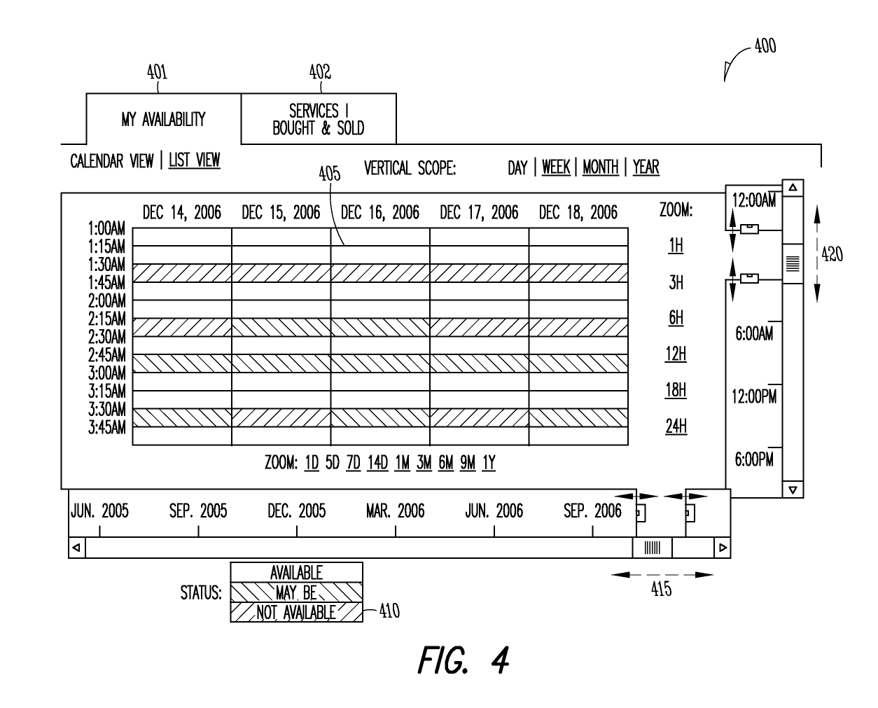

A time slot may be associated with a state which may be used to indicate whether a time slot is available, possibly available, or not available. An example of the different states is illustrated in FIG. 4 and labeled as status 410. A time slot may be in a published state, an uncommitted state, a committed state, etc. In the published state, the time slot may be available; in the uncommitted state, the time slot may be pending; in the committed state, the time slot may not be available.

For some example embodiments, a state of a time slot may change depending on actions of a supplier or a consumer. For some other embodiments, a number of available time slots associated with a time-valued resource may change. For example, a supplier or a consumer may add more time slots associated with a time-valued resource. The supplier or consumer may reduce the time slots associated with a time-valued resource. The state of a time slot may change from the committed state to the published state thus making that time slot available.

An online calendar (described below) may be provided by the matching system. The online calendar may display multiple time slots and may include an interface to manage the time slots. The time slots may be arranged using various arrangements. There may be a default arrangement. A supplier or a consumer may also arrange the time slots as desired. For example, the time slots may be arranged in a single range of availability consisting of one or more time slots. There may be multiple ranges of availability consisting of one or more time slots in each range, where the ranges may repeat. The time slots may be arranged according to a specific period or in a random interval. Other time slots arrangement may also be possible.

### V/ Calendars

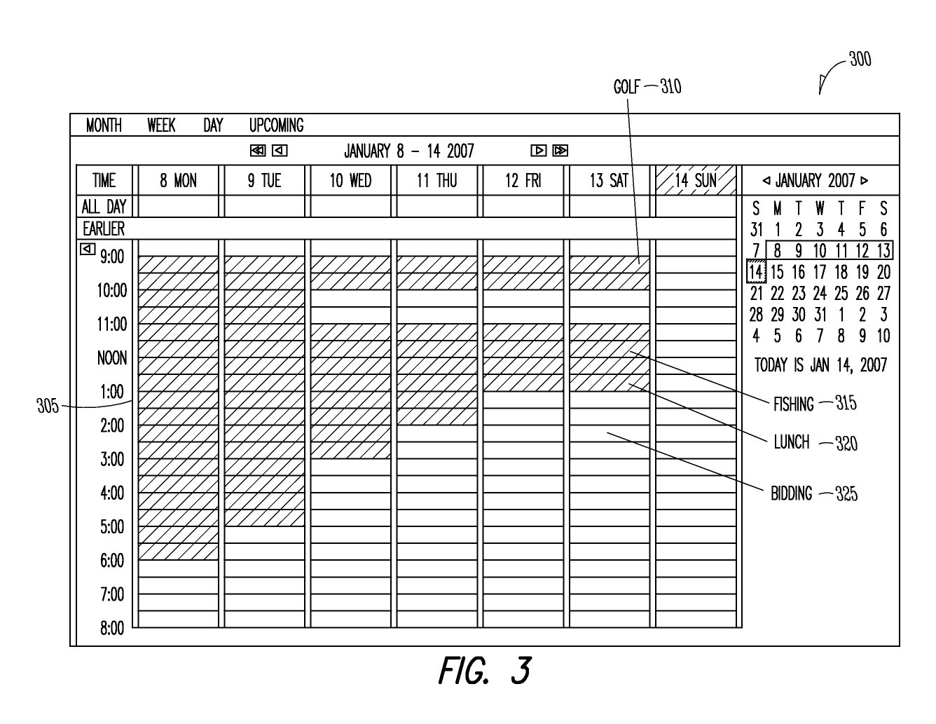

FIG. 3 illustrates an example of an online calendar, in accordance with some example embodiments. Online calendar 300 is illustrated in this example. A supplier has blocked the time slot from noon to 1:00 p.m. for lunch 320. There are various time slots 310 and 315 committed for golfing and fishing, respectively. There are some time slots 325 where bidding is still in progress. When an auction is complete, the online calendar 300 may illustrate a change in the status of the affected time slot.

FIG. 4 illustrates an example of an online calendar that may be used by a supplier or a consumer, in accordance with some example embodiments. In this example, the online calendar 400 includes options to allow a supplier or a consumer the ability to select a span of days 415 at the bottom of the diagram, with the ability to adjust the view area by increasing or decreasing the window view size. In the same way, there is the ability to adjust the view area of the hours 420 in a day on the right side of the diagram. Shown in the main area are the time slots (e.g., time slot 405) indicating the status 410 of either “Available” (no commitment yet), “Maybe” (commitment is pending) or “Not Available” (committed or blocked out). The status of the time slots may be coded for ease of visibility. The coding may be based on color, pattern, etc.

The online calendar 400 illustrated in FIG. 4 may include tab 401 (my availability) to display information associated with the availability of the supplier, and tab 402 (services I bought and sold) to display information associated with the timed value resources that have been bought and/or sold by the supplier.

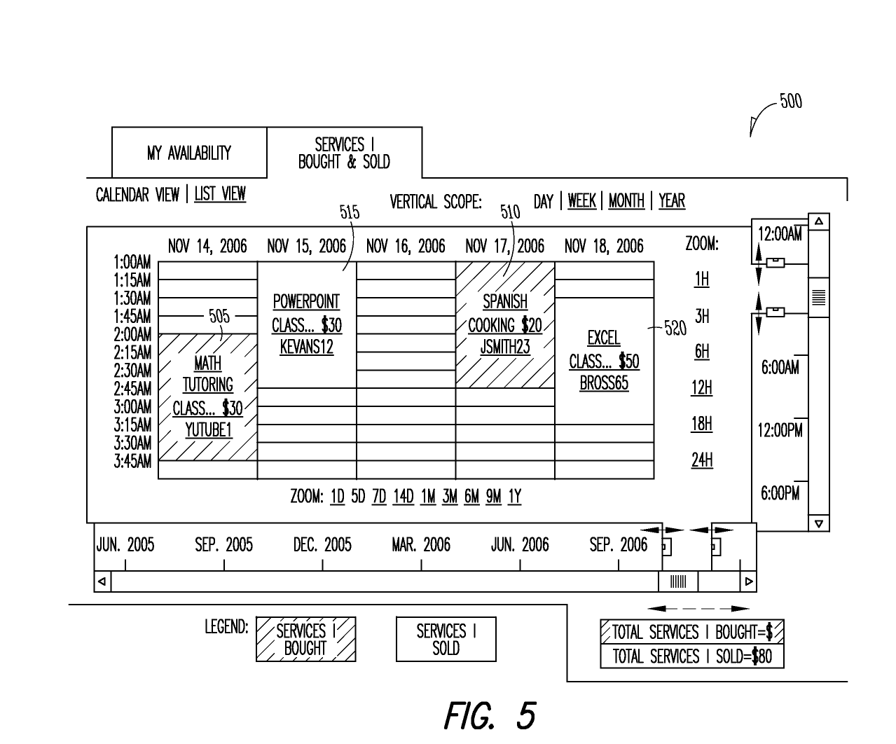

FIG. 5 illustrates another example of an online calendar, in accordance with some example embodiments. Online calendar 500 includes descriptions of the time-valued resources associated with the different time slots. The online calendar 500 includes time slots that illustrate math tutoring class 505, Spanish cooking class 510, PowerPoint class 515, and Excel class 520.

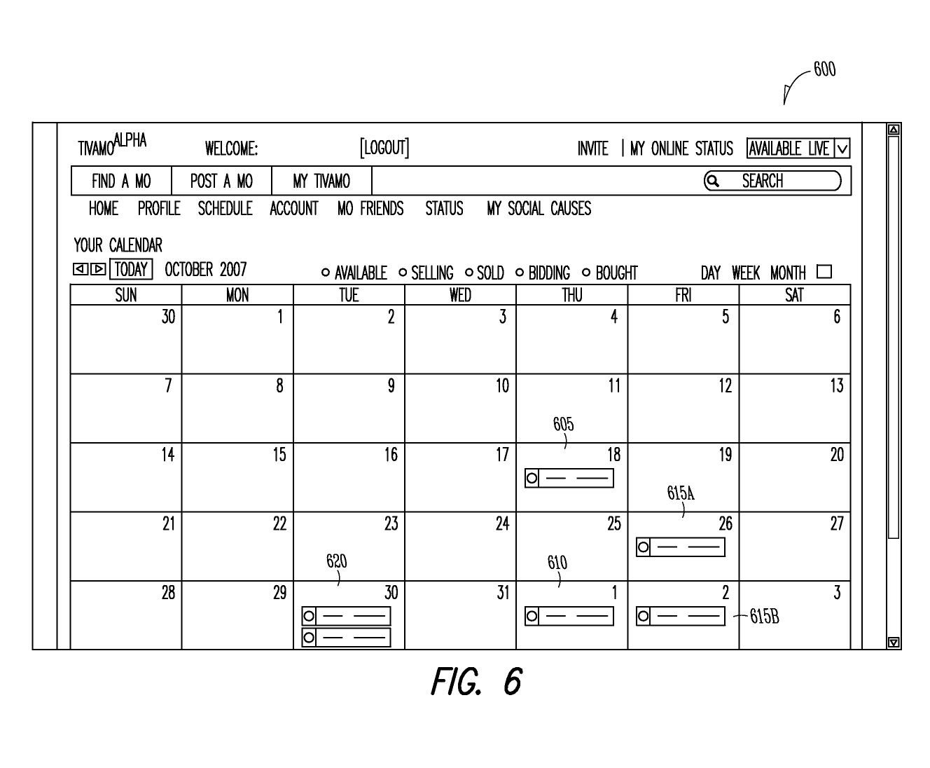

FIG. 6 illustrates another example of an online calendar, in accordance with some example embodiments. Online calendar 600 illustrates a daily view. There are time slots in day 605 and day 610 that are committed for taking learning a topic and a cooking class, respectively. There is a set of time slots in days 615A and 615B indicating offering of power walking classes, but these classes have not been committed or purchased by any potential consumers. Day 620 includes two time slots with two different activities.

When a time-valued resource is available, a supplier may use an interface provided by the matching system to enter information and to publish availability of the time-valued resource. This may enable the matching system to make the time-valued resource known to the potential consumers. A time-valued resource published by a supplier may be referred to as a listing, or alternatively as a monetizable unit (MO) according to some example embodiments. Additional references to the MOs may be specified in the interfaces provided by the matching system and described below. For some example embodiments, the availability of a time-valued resource may be temporal.

The supplier may enter or list the attributes associated with each of the time-valued resources. The supplier may also enter or list the time slots that may correspond to when the time-valued resources are available. For example, a supplier may offer his programming skill to potential consumers during a time slot from 4 p.m. to 6 p.m. on Oct. 28, 2007. The same supplier may offer usage of his motorcycle to potential consumers during two other different time slots. Information associated with the attributes and with the time slots may be stored in one or more databases. For some example embodiments, the suppliers who want to be able to list the time-valued resources may need to be registered with the matching system.

The time slots and the attributes of the time-valued resources from a supplier may be displayed on an online calendar. The supplier may be able to access and view the online calendar. There may be multiple views. For example, there may be a detailed hourly view, a daily view, a monthly view, a summary view associated with the same time-valued resource over an extended period of time, etc. The online calendar may include options to enable the supplier to generate custom views.

The online calendar may display time slots in a particular day (e.g., time slot 305 illustrated in FIG. 3). The online calendar may also display a brief description of a time-valued resource (e.g., description 505 illustrated in FIG. 5) that is associated with a time slot. The online calendar may display the time slots that are not associated with any time-valued resources (e.g., available slot 405 illustrated in FIG. 4). For some example embodiments, the online calendar may display the time slots using different graphical representation to reflect a state of each of the time slots, as illustrated in FIGS. 3-6. The graphical representations may include color representations, pattern representation, shade representation, numeric representation, alphanumeric representation, or any other forms of representation. Other information related to the time-valued resources may also be displayed on the online calendar.

The online calendar may be one of the major components of the matching system. The online calendar may include information about available time-valued resources and needed time-valued resources. Time may be divided into a number of time slots. A time slot may be the smallest relevant time unit used in the matching system for the purpose of matching time-valued resources with potential suppliers and potential consumers.

For some example embodiments, the matching system may enable the supplier or the consumer to synchronize information on a personal electronic calendar into the online calendar of the matching system. For example, a supplier may select an option using the online calendar interface to activate the synchronization with the personal electronic calendar. The personal electronic calendar may be a calendar application configured to run on a personal computer system, a portable electronic device, etc.

For some example embodiments, for global convenience, time division may start at the beginning of each hour. Each hour may be divided into a whole number of divisions. For example, a time slot may be 15 minutes long resulting in four time slots in each hour (e.g., 0:00-0:15, 0:15-0:30, 0:30-0:45, 0:45-1:00). However, in accordance with such an embodiment, it may not be possible to start a time slot at 25 minutes past the hour. Other time division techniques may be used depending on the application of the matching system. For example, it may be more convenient to have hourly based time slots when the application is for time-valued resources that normally take hours to consume or delivered.

A consumer or a supplier may use the online calendar to specify the available time slots and the attributes of time-valued resources that the supplier or the consumer wishes to fill the available time slots. For example, an online calendar may be expressed with the following information:
Duration—a start time and an end time (e.g. 10:00 AM-5:00 PM). The start time and end time of the duration may be aligned with the start time of one timeslot and the end time of the same or later time slot, respectively.
Recurrence—different patterns of predictable recurrence such as:
One-off (no recurrence)
Daily—e.g. every day or every weekday
Weekly—one day per week (e.g. every Saturday) or multiple days per week (e.g. every Friday, Saturday and Sunday)
Monthly—e.g. 28^{th} of every month
Recurrence Exit Scenario—this may involve one of the following situations:
Repeat for a number of times
Repeat until a certain date
Repeat for a specific period of time
Scattered—an unpredictable pattern of recurrence, where the consumer or supplier specifies each timeslot individually since there may not be any repetitive pattern to the recurrence.
Exceptions—An exception is a block of time to be made unavailable that is otherwise within the availability range. It may be due to unavailability (in which case the supplier or the consumer can manually enter the exception information), or blocked by the matching system automatically when the time period is being committed into an agreement. An example of exceptions may be: 4:00 PM-5:00 PM on May 16^{th}.
Unit of Delivery—A supplier or a consumer may want to specify the desired length of delivery (which may also be a whole number multiple of the timeslot unit).

### VI/ Interface and Categorization

For some example embodiments, the matching system may provide an interface to enable the suppliers and consumers to manage the online calendar and the related agreements. The interface may also enable the suppliers and the consumers to efficiently identify the time-valued resources. Some examples of the matching interfaces are described below.

The interface may display the calendar of availability with a graphical representation of the supplier's schedule. The interface may display the time-valued resources along with the status indication such as, for example, listed, pending, contracted, etc. The interface may also display similar information associated with a consumer. The interface may allow the consumers and the suppliers to manually categorize the listings or the information associated with the time-valued resources. There may be one or more interfaces for the suppliers and one or more interfaces for the consumers.

For some example embodiments, the matching system may automatically build a categorization of time-valued resources based on the description of the time-valued resources. The matching system may deliberate a set of prompts for the suppliers and the consumers to provide additional information to confirm the categorization. This may allow for the population of categories automatically, without the need for a group of maintenance personnel to manage and structure the categories.

### VII/ Manual Search

For some example embodiments, the consumers may use an interface provided by the matching system to manually search the databases to find listings from the suppliers that may satisfy the needs of the consumers. A consumer using the interface may need to provide the attributes of the needed time-valued resources. The consumer may also need to enter the time slots for the needed time-valued resources.

When a potential match is found, the consumer may indicate to the matching system that the consumer is interested, and the matching system may then notify the supplier. Any notification techniques may be used, although online communications may be preferred. It may be noted that a consumer may not need to be registered with the matching system to perform manual searches. In general, the ability to search and view the listings in the matching system may be open to any legal person or entities. The consumer, however, may need to be a registered user (or an account holder) to indicate to the matching system that the consumer is interested in a time-valued resource.

### VIII/ Automatic Search

For some example embodiments, the potential consumers may use the matching system to automatically search the databases to find listings that may represent one or more potential matches. In these situations, the consumer may use an interface to enter the attributes and the time slots associated with the needed time-valued resources. The consumer may then publish the information associated with the needed time-valued resources and their time slots. The matching system may then search the databases on behalf of the consumer.

For some example embodiments, when one or more potential matches are found by the matching system, notifications may be sent to the consumer and to one or more suppliers associated with the potential matches. Any notification techniques may be used, although electronic notifications may be preferred.

For some example embodiments, the need for a time-valued resource may be temporal. For some example embodiments, the consumers who want to be able to use the matching system to perform automatic searches may need to be registered with the matching system. A registered consumers (or account holders) may be able to access or view an online calendar. Some examples of the online calendars are illustrated in FIGS. 3-6.

Since a supplier may be a consumer and vice versa, the online calendar may display listings associated with available time-valued resources as well as needed time-valued resources. The time slots not associated with a listing may also be displayed in the online calendar. These time slots may be illustrated as available. For some example embodiments, when a supplier or a consumer changes the availability or the need of a published time-valued resource, the online calendar may be dynamically updated to reflect a corresponding change in one or more time slots.

For some example embodiments, a supplier or a consumer may be able to configure the online calendar to display only the available time-valued resources (or calendar of availability), or only the needed time-valued resources (or calendar of needs), or both. There may be other options for displaying including, for example, displaying only open time slots so a supplier or a consumer can make a decision as to whether to publish more listings, displaying only committed or pending time slots, displaying time-slots with commitment to a particular consumer or supplier, displaying only pending time slots, and so on.

### IX/ Time-Aware or Calendar-Aware Matching

The matching system may be aware of a calendar of availability (or non-availability) of a time-valued resource, and a calendar of needs (or non-needs) of a time-valued resource. For some example embodiments, the matching system may perform operations similar to operations performed by a broker in matching needs of time-valued resources with availability of time-valued resources. The matching system may identify potential matches and may manage agreements associated with the potential matches.

The identification of a potential match may be based on the attributes of a time-valued resource, its associated calendar of availability as provided by a supplier, and its associated calendar of needs as provided by a consumer. For some example embodiments, the matching system may generate a match between a supplier and a consumer based on a time slot or based on a series of time slots.

When a potential match is identified, the matching system may present it to the affected supplier and consumer. When the match is mutually agreed by the supplier and the consumer, an agreement may be created. The agreement may bind the time-valued resource, the associated time slot, the supplier and the consumer. The time-valued resource may be delivered from the supplier to the consumer during the time slot, and upon completion of the exchange of the time-valued resource, the agreement may be terminated.

Determining the completion of the delivery may vary depending on the time-valued resource. For example, when the time-valued resource is a service, then the delivery of the time-valued resource may be completed when the supplier completes the performance of the service, or when the time slot expires. When the time-valued resource is a tangible item, then the delivery of the time-valued resource may be completed when the consumer finishes using the item, or when the time slot expires.

For some example embodiments, the matching system may manage the agreement from a time the agreement is created until a time when the agreement is terminated. For some example embodiments, the matching system may also include options to allow the supplier, the consumer, or both to prematurely terminate the agreement, to modify the agreement, or to move the agreement to another time slot, etc.

### X/ Types of Matches

The matching system may enable any supplier to enter into an agreement with any consumer. A supplier may list one or more time-valued resources with the matching system. A consumer may list one or more time-valued resources with the matching system. The consumer may use the manual approach to search. Alternatively, the consumer may use the automatic approach to search, as described above.

There may be multiple consumers who may be searching for a similar time-valued resource. There may be multiple suppliers who may provide a similar time-valued resource. The matching system may use the attributes of the time-valued resources, the calendar of availability, and the calendar of needs entered by the suppliers and the consumers to identify the potential matches.

The matching system may present the potential matches to a consumer. For some example embodiments, the consumer may select from one or more potential matches and may commit to one or more time slots associated with a potential match. Various other combinations of agreements and time slots may also be allowed by the matching system. These combinations may include, for example, having more than one agreement with a given time-valued resource for different time slots, having more than one agreement with multiple time-valued resources for different time slots, having more than one agreement with multiple time-valued resources for the same time slot, etc.

For some example embodiments, multiple consumers may enter into agreements associated with a common time slot and a common time-valued resource if the time-valued resource allows multiple simultaneous agreements. A consumer may enter into multiple simultaneous agreements for multiple time-valued resources associated with a given time slot if the consumer allows such arrangement. Multiple consumers may enter into agreements for multiple time-valued resources associated with a given time slot when each of the multiple consumers allows such arrangement.

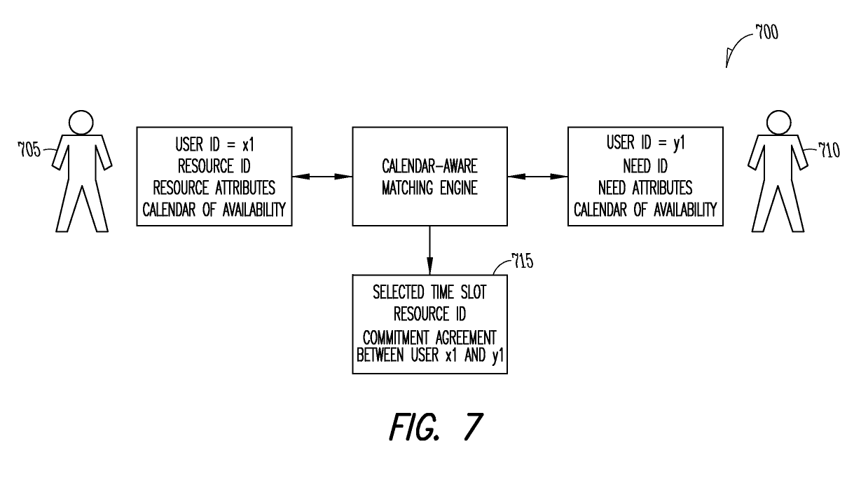

FIG. 7 is a block diagram that illustrates a matching example with one agreement, in accordance with some example embodiments. The diagram illustrates an example situation with one supplier and one consumer, from a possible collection of multiples of each. In this example, supplier 705 offers a time-valued resource described by the attributes and a calendar of availability that indicates when that time-valued resource is available. The example also illustrates that consumer 710 needs a time-valued resource described by the attributes and a calendar of needs that indicates when the time-valued resource is needed.

The supplier 705 and the consumer 710 may interact with the matching engine 700. An example of a matching engine is described with FIG. 12. The interaction with the matching engine 700 may include publication of a listing of a time-valued resource by the supplier 705. The interaction may also include a search or publication of a listing of a time-valued resource needed by the consumer 710.

When the matching engine 700 identifies one or more potential matches for the supplier 705 and the consumer 710, the potential matches may be presented to the supplier 705 and the consumer 710 for review. An agreement 715 may be entered between the supplier 705 and the consumer 710. The agreement 715 may include relevant factors that may be agreed upon by the supplier 705 and the consumer 710. The relevant factors may include, for example, a selected time slot, a time-valued resource identifier, and the identities of the supplier 705 and the consumer 710. Other useful information may be contained in the agreement 715 and may vary depending on the application of the matching engine 700.

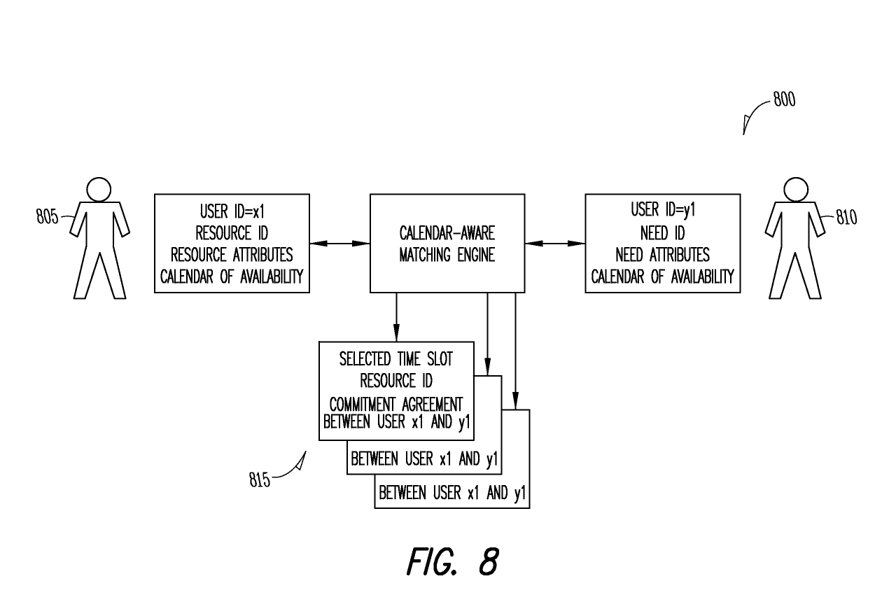

FIG. 8 is a block diagram that illustrates a matching example with multiple agreements, in accordance with some example embodiments. The diagram illustrates an example situation with one supplier and one consumer, from a possible collection of multiples suppliers and multiple consumers. In this example, supplier 805 offers a time-valued resource described by the attributes and a calendar of availability. The example also illustrates consumer 810 who needs a time-valued resource described by the attributes and a calendar of needs.

The supplier 805 and consumer 810 may interact with the matching engine 800. The interaction with the matching engine 800 may include the publication of the listing of one or more time-valued resources offered by the supplier 805. The interaction may include searches by the consumer 810 (or automatic search by the matching engine 800 on behalf of the consumer 810) for one or more time-valued resources needed by the consumer 810. The interaction may include their review of potential matches identified by the matching engine 800, their selection of one or more potential matches, and their intention to enter into and to complete one or more agreements. In this example, there are three agreements 815 between the supplier 805 and the consumer 810. These agreements 815 may be for different time slots but may involve only one time-valued resource. That is, the same time-valued resource may be made available by the supplier 805 and will be used or consumed by the consumer 810 during three different time slots.

The agreements 815 may include relevant information that may be agreed upon by the supplier 805 and the consumer 810. The relevant information may include, for example, a selected time slot, a time-valued resource identifier, identities of the supplier 805 and consumer 810, etc. Other useful information may be contained in the agreements 815 and may vary depending on the application of the matching engine 800.

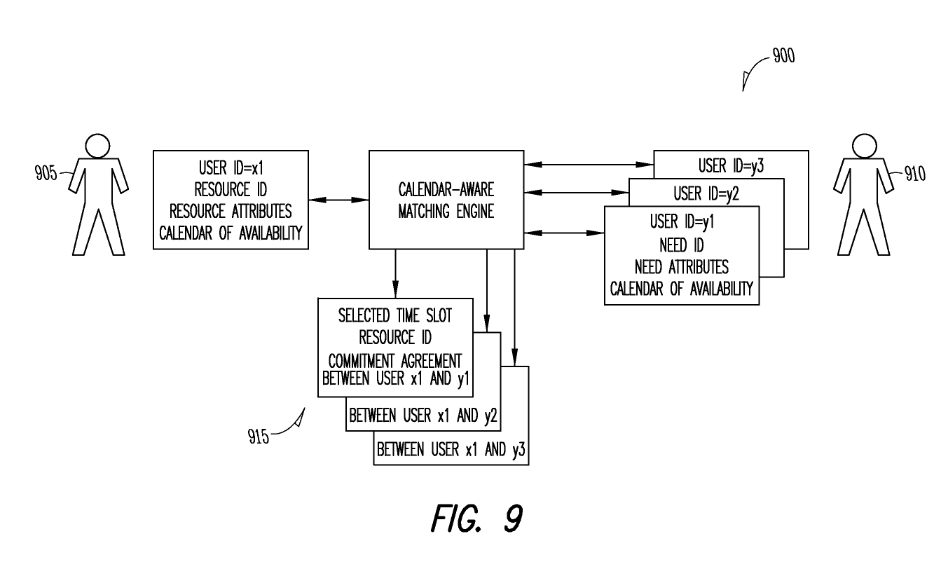

FIG. 9 is a block diagram that illustrates a matching example with multiple consumers and one supplier, in accordance with some example embodiments. In this example, supplier 905 offers a time-valued resource described by the attributes and a calendar of availability. The example also includes multiple consumers 910 who need time-valued resources described by the attributes and the calendar of needs. The consumers 910 may publish their needs as listings. It should be noted that the needs for the time-valued resources, the attributes of the time-valued resources, and the calendars of needs may be identical in all three depicted listings, or they may be different in one or more aspects.

The supplier 905 and the consumers 910 may interact with the matching engine 900. The interaction may include the publication of the listings by the supplier 905 and the consumers 910, their review of potential matches identified by the matching engine 900, their selection of the one or more potential matches, and their intention to enter into and to complete one or more agreements. In this example, there are three agreements 915. The agreements 915 may be for different time slots which may indicate that the time-valued resource from the supplier 905 may be made available to the three consumers 915 at three different times or during the same time.

The agreements 915 may include relevant information agreed upon between the supplier 905 and each of the three consumers 910. The relevant factors may include, for example, a selected time slot, a time-valued resource identifier, identities of the supplier 905 and consumers 910, etc. Other useful information may be contained in the agreement 915 and may vary depending on the application of the matching engine 900.

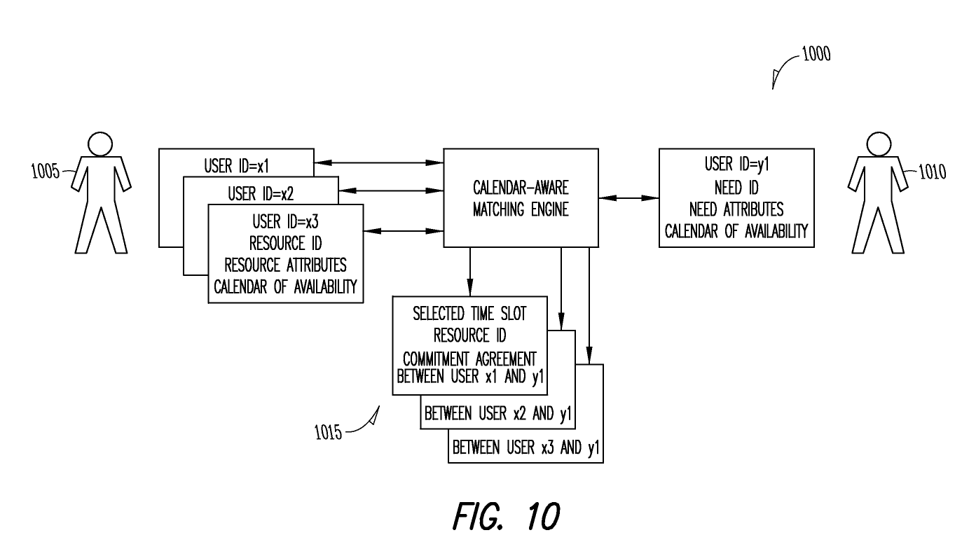

FIG. 10 is a block diagram that illustrates a matching example with multiple suppliers and one consumer, in accordance with some example embodiments. In this example, suppliers 1005 may offer time-valued resources described by the attributes and a calendar of availability that indicates when each particular time-valued resource from each of the suppliers 1005 is available. The example also includes a consumer 1010 who has a need for a time-valued resource described by the attributes and the calendar of needs. It should be noted that the time-valued resources from the suppliers 1005, the attributes of the time-valued resources, and the calendars of availability may be identical in all three depicted listings, or they may be different in one or more aspects.

The suppliers 1005 and the consumer 1010 may interact with the matching engine 1000. The interaction with the matching engine 1000 may include the publication of the listings by the suppliers 1005 and the consumer 1010, their review of potential matches identified by the matching engine 1000, their selection of one or more potential matches, and their intention to enter into and to complete one or more agreements. In this example, there are three agreements 1015. The agreements 1015 may be for different time slots or for the same time slot, indicating that the three time-valued resources may be made available by the suppliers 1005 and used or consumed by the consumer 1010 at three different times or at the same time.

The agreements 1015 may include relevant factors agreed upon by the suppliers 1005 and the consumer 1010. These relevant factors may include, for example, a selected time slot, a time-valued resource identifier, and identities of the supplier 1005 and consumer 1010. Other useful information may be contained in the agreement 1015 and may vary depending on the application of the matching system 1000.

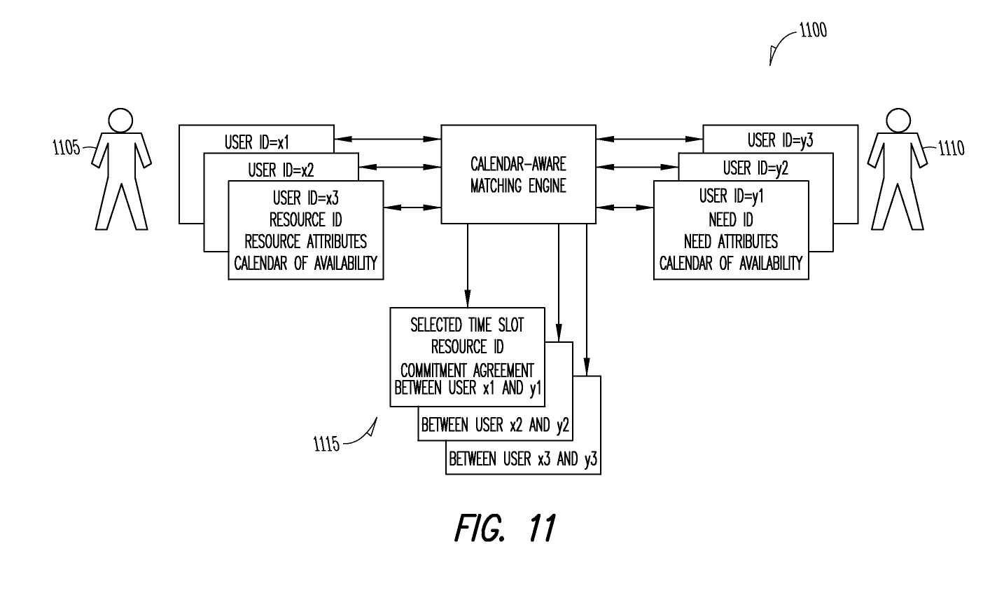

FIG. 11 is a block diagram that illustrates a matching example with multiple consumers and multiple suppliers, in accordance with some example embodiments. In this example, suppliers 1105 may offer time-valued that are described by the attributes and a calendar of availability that indicates when each particular time-valued resource from each of the suppliers 1105 is available. The example also includes consumers 1110 who need time-valued resources described by the attributes and the calendar of needs. It should be noted that the needs for the time-valued resources, the attributes of the time-valued resources, and the calendars of needs may be identical in all three depicted listings, or they may be different in one or more aspects. It should also be noted that the time-valued resources from the suppliers 1105, the attributes of these time-valued resources, and the calendars of availability may be identical in all three depicted listings, or they may be different in one or more aspects.

The suppliers 1105 and the consumers 1110 may interact with the matching engine 1100. The interaction with the matching engine 1100 may include the publication of the listing by the suppliers 1105 and the consumers 1110, their review of the potential matches identified by the matching engine 1100, their selection of the one or more potential matches, and their intention to enter into and to complete one or more agreements. In this example, there are three resulting agreements 1115. These agreements 1115 may be for different time slots, indicating that the each time-valued resource may be made available and be used or consumed possibly at three different times or at the same time and in this case by three different consumers 1110.

The agreements 1115 may include relevant factors agreed upon by the suppliers 1105 and the consumers 1110. These factors may include, for example, a selected time slot, a resource identifier, identities of the suppliers 1105 and the consumers 1110, etc. Other useful information may be contained in such an agreement and may vary depending on the application of the matching engine 1100.

### XI/ Panel Organization

For some example embodiments, the matching engine may support organizing a variety of time-valued resources in a bundle or a panel. A panel may have as few as one time-valued resource, in which case supplying a panel is similar to supplying one time-valued resource. The panels may be organized in sequential order, parallel order, scattered order, or a combination of these. The panels may be organized in a many-to-one approach (or collaborative approach), where multiple suppliers may provide one or more time-valued resources to one consumer. The panels may also be organized in a many-to-many approach (or conference approach), where multiple suppliers may provide one or more resources to multiple consumers. A moderator, assembler, or organizer of a panel may either be a supplier, a consumer, or a third-party acting as a broker or reseller.

For some example embodiments, the matching system may allow reselling a panel as long as it is acceptable for all of the components (the individual time-valued resources) of the panel to be resold. Governmental restrictions, other regulatory restrictions, or restrictions from the original owners may prevent a time-valued resource or a panel containing the time-valued resource to be resold. In these situations, a consumer may want to search for and enter into an agreement only with suppliers who are the original owners. For some example embodiments, the matching system may be configured to comply with these restrictions wherever the matching system is implemented.

For some example embodiments, a supplier may organize panels, in which case, the consumers may acquire a panel in whole rather than the individual component time-valued resources within a panel. This type of panel may typically consist of multiple time-valued resources provided by a given supplier.

For some example embodiments, a reseller may organize panels, in which case, the consumers may acquire a panel in whole rather than the individual component time-valued resources within a panel. This type of panel may typically consist of a collection of time-valued resources provided by multiple suppliers. The reseller may receive the payment (when applicable) from the consumer for the panel of the time-valued resources consumed. The reseller may, in turn, make payments (when applicable) to the individual suppliers. This approach provides the opportunity for the reseller to earn a profit for the service of assembling the panel.

For some example embodiments, an organizer of a panel may assemble a series of time-valued resource offerings from one or more suppliers. In this situation, the complete panel may be acquired by a consumer in whole if all component time-valued resources may be acquired. It may be acquired in part if only some component time-valued resources may be acquired. It may not be acquired if one or more of the component time-valued resources cannot be acquired. This panel may then be offered to one or more consumers by the organizer, in which case the organizer acts as a reseller.

For some example embodiments, an organizer may assemble a reverse-bid panel by assembling a series of needs, where multiple suppliers compete to provide the needed resources. This type of panel may enter into an agreement only when all of the needs can be satisfied within the parameters specified by the consumer and the supplier. When any one of the needs remains unsatisfied, the panel may not be finalized, and the consumer may have to decide what course of action to take after being notified of the status of the panel search. This panel may then be offered to one or more other consumers by the organizer, in which case the organizer acts as a reseller.

For some example embodiments, a panel may also be used by a consumer as a collection or a composite of needs. The consumer may desire to find multiple time-valued resources that may be assembled into a panel. The time-valued resources in this panel may be scattered. They may also be sequential or parallel. For example, a consumer traveling to Europe may want to have lessons in French, Italian, and Spanish. The consumer may create a composite listing of needs (or panel), and the consumer may only commit if all three language lesions can be delivered within stated parameters of time, etc.

For some example embodiments, the consumer may act as an organizer and collect multiple needs. The multiple needs may be from the consumer or from multiple entities (e.g., a group of friends), and they may be grouped to form a panel of needs. The multiple needs may represent combinations of similar and/or different time slots with combinations of similar and/or different needs. The consumer may only commit if all of the time slots and needs requirements are met by combinations of a single supplier, by multiple suppliers, or by a panel of multiple suppliers. The matching system may provide the consumer an interface to set up complex or composite search parameters to address these situations before deciding whether to commit.

### XII/ Proxy Commitment

For some example embodiments the matching system may automatically engage a supplier or a consumer into an agreement based on specified requirements for attribute match criteria. This may be referred to as proxy commitment. This feature may offer the consumers and the suppliers the ability to allow the matching system to secure an agreement without the direct involvement of the consumers and the suppliers when a potential match becomes available. With the proxy commitment feature, the matching system may be more responsive compared to a matching system that requires a consumer or a supplier to make a decision when a potential match becomes available. This is because the consumer or the supplier may not be actively engaged with the matching system at the time that the potential match is identified.

For some example embodiments the required attribute match criteria may specify attributes that may need to be included, or attributes that may need to be excluded, or a combination of both. Specification of attributes, whether for inclusion or exclusion, may include one or more attributes. In cases where the attributes may have variable values, the specification for the attribute may include, for example, limits on upper values, limits on lower values, range combinations of upper and lower values, a specific set of values, or a combination of ranges, limits, or sets of specific values.

For some example embodiments, the matching system may exercise control of the proxy commitment feature in one or more of several ways including, for example, specification of which users may exercise this feature and specification of which proxy match criteria may be revealed to users who are allowed to use the feature.

Some examples of the specification of which users may exercise the proxy commitment feature include system-wide basis, groupings-of-users basis, per-user basis, or a combination of groupings-of-users and per-user basis. With the system-wide basis, all users on the system collectively may or may not be allowed to use the proxy commitment feature. With the grouping-of-users basis, all users belonging to some grouping may or may not be allowed to use the proxy commitment feature. The administrator or operator of the matching system may decide which groupings are allowed or disallowed. There may be one or more groupings of users defined in the matching system. With the per-user basis, each individual user in the matching system may or may not be allowed to use the proxy commitment feature. The administrator or operator of the matching system may decide which users are allowed or disallowed.

Some examples of the specification in which proxy match criteria may be revealed to users who are allowed to use the feature include pre-determined match criteria, list of user-specifiable attributes for the purpose of proxy match, and combination of both. With the pre-determined match criteria, a selection of various pre-determined match criteria may be available for one or more users, one or more groupings of users, a combination of users and groupings of users, or on a system-wide basis. The administrator or operator of the matching system may define such pre-determined criteria. With the list of user specifiable attributes for the purpose of proxy match, a selection of attributes that users who are allowed to use the feature may specify for the purpose making a proxy match.

### XIII/ Improving Matches

For some example embodiments, depending on the application for the matching system, various methods for improving the matches may be applied. For some example embodiments, the matching system may offer users options to manually improve match results, automatically improve match results, or a combination of both. Some examples of different techniques to improve the match results may include prioritizing the time slots and prioritizing one or more attributes.

When the time slots are prioritized, the number of potential matches may be different. For some example embodiments, the users may assign a different priority to one or more time slots. Some examples may include the supplier filling the schedule, the consumers giving priority to a particular time slot or multiple time slots, or assigning a ranked priority to a series of multiple time slots.

For some example embodiments, one or more attributes of a time-valued resource may be prioritized to affect change in the number of potential matches. The users may assign a ranked priority to one or more time slots. One example of an attribute that may be prioritized include value of time slot where the value can vary across time slots for a given resource, where the value of the same time slot varies across resources, or a combination of both. Another example of an attribute that may be prioritized includes the value of the time-valued resource where the different values of different time-valued resources are considered. Another example include usage spread across one or more specified time-valued resources of a given user over one or more specified time periods. For example, a user may have multiple time-valued resources, and there may be a desire to cause an even usage of the various time-valued resources over some period of time.

For some example embodiments, the attribute that is location sensitive may be adjusted or prioritized to improve potential match results. The location attributes may include: distance from specified location, distance outside of a specified location, or a combinations of both. A user may use this approach to narrow the potential matches to within a specified distance of a given location.

For some example embodiments, the location may be specified as a coordinate, address, ZIP code, area code, time zone, or other relevant method. For some example embodiments, the distance may be specified as a radius distance, range of distance, or ranges of distances, from the center of the specified location expressed in some recognizable measure such as miles or feet.

For some example embodiments the system may provide a means for a user to specify a premium or a discount depending on the location and distance. An example of this may be when a service is to be provided at a consumer's location, the distance from the supplier of that service may be considered as a factor in the value (or cost) of that service.

For some example embodiments, there may be implemented a ranking system which assigns a rank rating to users (or resources). In such embodiments, the system may offer the ability for a user to specify a ranking requirement for matches. Examples may include only users with ranking above some specified limit.

For some example embodiments, the matching system may offer a feature to assign different priorities to different ranking and rating levels. The matching system may include options to specify which users may exercise this feature, and to specify which criteria may be revealed to users who are allowed to exercise the feature. For examples, specification as to the users that may exercise the features may be on a system-wide basis where all users on the system collectively may or may not be allowed to use the feature. It may be on a grouping-of-users basis where all users belonging to some grouping may or may not be allowed to use the feature. The administrator or operator of the matching system decides which groupings are allowed or disallowed. There may be one or more groupings defined in the matching system. It may be on a per-user basis where each individual user on the matching system may or may not be allowed to use the feature. The administrator or operator of the matching system decides which users are allowed or disallowed. It may also be combinations of groupings and individual user basis.

Specification as to which optimization criteria may be revealed to users who are allowed to use the feature may include, for example, predetermined match criteria, list of user specifiable criteria for the purpose of optimization, or combinations of both. As for the pre-determined match criteria, a selection of various pre-determined match criteria may be available for one or more users, one or more groupings of users, a combination of users and groupings, or on a system-wide basis. The administrator or operator of the system may define such pre-determined criteria. As for the list of user specifiable criteria for the purpose of optimization, this involves a selection of attributes (and/or time slot) that the users who are allowed to use the feature may specify for the purpose of optimization.

### XIV/ Analysis

Values of the time-valued resources may be affected as time passes. As such, a time-valued resource that is not engaged in an agreement may lose value as the time approaches the associated time slot or time slots (or desired target time). For some example embodiments, the consumers and/or the suppliers may be able to adjust the attributes associated with the time-valued resources in these situations to attract interests. For some example embodiments, the matching system may be configured to suggest changes to the consumers and/or to the suppliers. For example, the matching system may monitor the status of published time-valued resources and identify opportunities for the supplier or consumer relating the value change of the time-valued resources when approaching a time event or deadline. In these situations, the matching system may notify the supplier or the consumer about the projected value change and suggest a course of action such as, for example, drop the price or increase the bid.

For some other embodiments, the matching system may automatically implement changes to the attributes (e.g., discounting) within certain criteria set by the affected consumers and/or suppliers. For some example embodiments, the matching system may be configured to provide an automatic change in the value or other attribute associated with a time-valued resource, as specified by the supplier or the consumer, to increase the chances of achieving a match and a commitment before a time event or deadline. The matching system may automatically implement changes to the attributes with certain criteria set by the affected consumers and/or suppliers to protect the perishability of the time-valued resources. The changes to the attributes may or may not include changes to the price or cost attribute.

For some example embodiments, the matching system may provide the consumers, or the suppliers, analysis features to modify the attributes and/or the calendar of needs or the calendar of availability for a particular time-valued resource to increase search results. This may be beneficial in generating some potential matches in the events when a search based on an original set of attributes may not provide a potential match. For example, the suppliers may make their available time-valued resources more attractive by modifying the price attributes (e.g., willing to sell for less), loosening the usage restrictions (e.g., lesson can be offered rain or shine), etc.

The suppliers may also make the time-valued resources more readily available by adding more time slots in the calendar of availability. Similarly, the consumers may make their needed time-valued resources more attractive by modifying the price attributes (e.g., willing to pay more), and requirements attributes (e.g., an item does not have to be brand new or does not have to be available within a 3 mile radius from a particular location or address).

By providing the consumers and the suppliers the analysis features to increase the number of potential matches in the search results, the matching system may be able to address situations such as, for example, when a consumer is unsatisfied with the then available potential matches, or when the consumer is unable to reach an agreement with a potential supplier, etc.

For some example embodiments, the suppliers and the consumers may use the matching system to find alternate matches by changing various attributes. For some example embodiments, the match-making system may offer manual, automated, or both methods to conduct such alternate matches and present the resulting choices to the user for selection. Examples of the various parameters that may be changed for analysis include change in specified time slots (calendar of availability), change in the value assigned for a time slot, change in the value assigned to a time-valued resource, change in location, change in the time-valued resource description or keywords, and any combinations of these changes.

The change in the specified time slot may include change in duration (number of consecutive time slots), number of non-consecutive time slots, time of day, day of week, date of month, month of year, or any possible combinations). Users may modify the time slot parameters listed above such that other, previously excluded, time slots become available for matching, thus, possibly resulting in a broader choice of possible match choices.

The change in value assigned for a time slot may include accepting a potential match at a higher value if the time slot choice is improved, or conversely accepting or seeking a lower valued match that may be offered at perhaps a less desirable time slot. The change in value assigned to resource may include adjusting the match parameters to accept a different value limit (upper, lower, or range) to possibly broaden the available matches. The change in location may include modifying the location specification in order to broaden the possible matches. The change in resource description or keywords may be used to broaden the scope of the time-valued resources in terms of description and/or keywords. This may enable the time-valued resources to be included in more search results.

For some example embodiments, when there are no readily available matching resources at the time of publication of a need or within some specified time thereafter, the matching system may process the need and notify a list of potential suppliers to give such suppliers the opportunity to offer time-valued resources in response to this need. For some example embodiments, finding or creating the list of the potential suppliers may be performed using an algorithmic approach that may take into consideration the semantics of the need. For example, the descriptive text of a need may be reduced to keywords. These keywords may then be matched to similar keywords associated with the potential suppliers or the potential suppliers' previous time-valued resource listings. Other methods for finding a list of potential suppliers for need may also be used. The potential supplier may be notified using one or more of the available communications techniques and may include, for example, email, postal mail, fax, voice calls, mobile text messaging, IM, or other means for notification.

Conversely, for some example embodiments, when there are no readily available matching needs at the time of publication of a resource or within some specified time thereafter, the matching system may process the published time-valued resource and notify potential consumers to give those potential consumers the opportunity to consider these published time-valued resources in response to an anticipated or unpublished need. Finding or creating the potential consumers may be performed using an algorithmic approach that may take into consideration the semantics of the resource. For example, the descriptive text of a resource may be reduced to keywords then these keywords may be matched to similar keywords associated with the potential consumers, or the potential consumers' previous published needs. Other techniques for finding the potential consumers for such the time-valued resources may also be used. The potential consumers may be notified using one or more of the available communications technique and may include, for example, email, postal mail, fax, voice calls, mobile text messaging, IM, or other means for notification.

For some example embodiments, the matching system may exercise control over the analysis feature by specifying which users may use the feature. This control may be on a system-wide basis where all users on the matching system collectively may or may not be allowed to use the analysis feature. The control may be on a groupings-of-users basis where all users belonging to some groupings may or may not be allowed to use the analysis feature. The administrator or operator of the matching system may decide which groupings of users are allowed or disallowed. There may be one or more groupings of users defined in the matching system. The control may be on a per-user basis where each individual user on the matching system may or may not be allowed to use the analysis feature. The administrator or operator of the matching system may decide which users are allowed or disallowed. The control may also be based on combinations of groupings and per-user basis.

For some example embodiments, the matching system may exercise control over the analysis feature by specifying which analysis criteria may be revealed to users who are allowed to use the feature. The analysis criteria may include pre-determined analysis criteria, list of user specifiable criteria for the purpose of optimization, and their combinations. With the predetermined criteria, a selection of various pre-determined match criteria may be available for one or more users, one or more groupings of users, a combination of one or more users and groupings of users, or on a system-wide basis. The administrator or operator of the matching system may define such pre-determined criteria. With the list of user specifiable criteria, this may involve selecting attributes (and/or time slot) that users who are allowed to use the feature may specify for the purpose of analysis.

For some example embodiments, the matching system may exercise control over the analysis feature using historical information. This may include usage patterns of prior activity and value (spent or earned) of prior activity of a user. With the usage pattern, the matching system may analyze the prior activity patterns of the user and combine the results with other specified or pre-determined analysis criteria. With the value criteria, the matching system may include one or more value attributes for a time-valued resource. In such embodiments, the historical spending or earning pattern of a user may be used to find matches that are better suited for that user.

### XV/ Matching Engine Module Diagram

FIG. 12 is a block diagram illustrating examples of modules that may be included in a matching engine, in accordance with some example embodiments. Illustrated is a matching engine example that may include data store module 1205, interface module 1210, search module 1240, user management module 1215, supplier resources management module 1220, derived attributes module 1225, customer needs management module 1230, calendar availability module 1235, data access module 1255, indexer module 1245, and rules engine module 1250. The matching engine may be implemented using software, hardware, or combinations of both software and hardware. The matching engine may be implemented in a local environment, or it may be implemented in a distributed environment.

The data store module 1205 may be a permanent storage for all the data that the matching system may need to be fully operational. Data may be managed and accessed through some form of data storage and retrieval subsystem such as a Database Management System (DBMS). Some examples of DBMS include Microsoft SQL Server, MySQL, and Oracle; a search engine, examples are Google Search Appliance and Apache Lucene (a text search engine); or, a file subsystem such as Network file system (NFS) and AmazonS3 (Simple Storage Service). The actual implementation may use combinations of such subsystems, with each subsystem being used for a specific type of data. For example, the matching engine may use a DBMS for user account information, and a file subsystem for image or video data, etc.

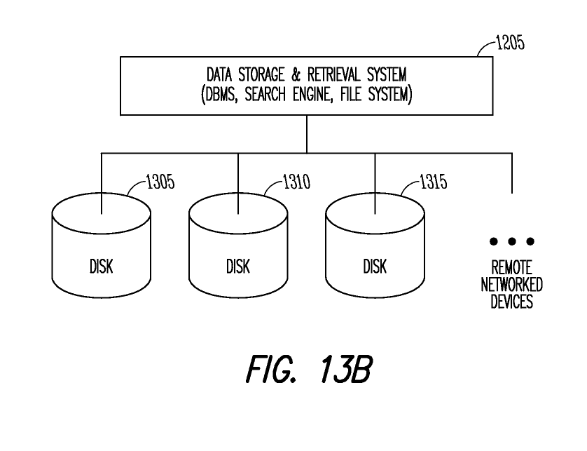

FIG. 13A illustrates an example of a data store module, in accordance with some example embodiments. The data store module 1205 may include data retrieval system 1300 which may include a DBMS, a search engine, and a file system. The data retrieval system 1300 may also have access to storage devices 1305-1315. The format of the data and how the data is physically stored in the storage devices 1305-1315 depends on the devices and data retrieval subsystems that are used. Data may be stored in a single device or distributed across multiple remote devices that are networked together. An example is illustrated in FIG. 13B.

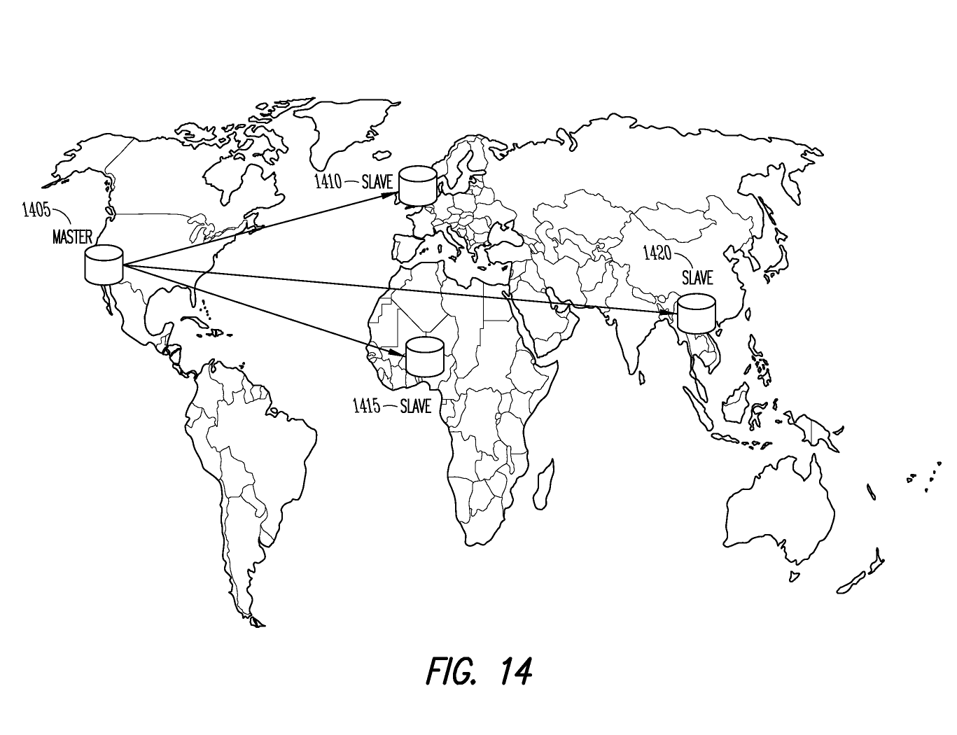

Data may also be replicated to multiple geographic locations in a master-slave configuration, where the data set is copied from the master location to all the slave locations. Matching engines running in different geographic locations may be configured to work with a data store that has close proximity to the matching engine to reduce network latency and improve overall system response. The use of Internet connectivity between the data store and the other parts of the system supports the deployment of the data stores to various locations across the globe, and such locations may be selected to optimize the operation of the matching engines. FIG. 14 illustrates an example of how a data store may be deployed on a global basis, in accordance with some example embodiments. In this configuration, there may be a master data store 1405 and multiple slave data store 1410-1420. It may be noted that the master-slave configuration described here should be viewed as one example configuration. Other configurations may also be used.

Data Access Module 1255 may be responsible for saving and retrieving data to/from the data store 1205. The data access module 1255 may be viewed as a logical representation for the underlying data store 1205. It provides a well-defined and comprehensive set of Application Programming Interfaces (API's) to support all the operations of the application. This layer facilitates the development of applications without specific knowledge of the data store implementations, and allows changes to any implementation of the data store without disturbing the application modules.

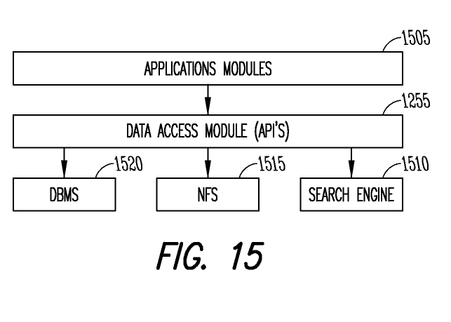

The data access module 1255 may include indexer 1245. One of the functionality of the index 1245 may be to construct an index to the data store 1205 for faster data look-up. For example, an index built on keywords may allow the matching engine to retrieve time-valued resources matching a particular keyword quickly, in smaller amounts of time than without such an index. FIG. 15 illustrates an example of a more detailed view of the data access module 1255, in accordance with some example embodiments. As illustrated, the data access module 1255 may be coupled to application module 1505, search engine 1510, NFS 1515, and DBMS 1520.

User management module 1215 may manage user accounts. In this example embodiment, each user (whether the user is a supplier or a consumer or both; each may also be referred to as an account holder (described below)) is required to establish an account to access the matching engine. An account may be a method for the matching engine to securely establish the identity of the user. Each account may be associated with a unique login user identifier (e.g., an email address) and a security password. Through the user management module 1215, users may maintain personal profile information, which may include, for example, a profile image (i.e. an avatar, described below) a short description about themselves, a description of their general interests, audio/video clips describing themselves or their resources, etc. Other helpful information includes their geographic location and time zone. Users are able to change or edit their login, password, and profile information at any time.

Supplier resources management module 1220 manages the time-valued resources provided by the suppliers. In an example embodiment, each time-valued resource may be defined by a number of attributes. These attributes help define and identify the nature of the time-valued resource. Examples include images/videos, description, keywords/tags, category, pricing, time-price weighting, location, distance-pricing weighting, etc. Through the supplier resource management module 1220, suppliers can define any number of time-valued resources they are able to provide. They can also edit or delete these time-valued resources at any time. Some example embodiments may allow the supplier to define the set of attributes, where each time-valued resource may be described by a set of custom defined attributes developed and populated by the supplier, or by system defined attributes that are populated by the supplier.

Consumer needs management module 1230 manages the needs associated with the consumers. In an example embodiment, the needs can be specified based on a number of attribute criteria such as keywords/tags, availability calendar, cost/price range, location, etc. Through the consumer needs management module 1230, users can define any number of needs. They can also edit or delete any of their needs at any time. Some example embodiments may allow the consumer to define the set of attributes, where each need may be described by a set of custom defined attributes developed and populated by the consumer, or by system defined attributes that are populated by the consumer.

For some example embodiments, some attributes associated with a time-valued resource may not come directly from the supplier. Derived attributes module 1225 may calculate attributes based on a pre-defined formula using other attributes as input values. An example of such attributes is ranking. A ranking system may be helpful for the consumers in determining the quality of a resource or the supplier of the resource. The output of the ranking system could be a numeric score that is associated with a particular resource. The score may be calculated based on consumer feedbacks, total time of service, supplier expertise, etc. The formula may differ depending on the type of resource. The derived attributes module 1225 is illustrated in the current example as being shared by the supplier resources management module 1220 and the consumer needs management module 1230.

Search module 1240 may be used to find information stored in the matching engine. The search module may provide a querying capability that is used for retrieving and finding matching data given some search criteria. Data that typically can be queried on are numeric values, date/time values, and text/string values. Custom types may also be defined as long as comparison methods are provided. Some common comparison operators include =, < >, >, <, >=, <=. Text-based searches may also support wildcard or regular expression queries. The search module may utilize any available indexes to help speed up a query. For some example embodiments, the search module 1240 may also match on more complex data forms. This may include, for example, matching on images or on custom defined attributes.

Rules engine module 1250 may help automate the process to determine best matches based on preference. The search module 1240 identifies potential matches and the rules engine module 1250 prioritizes and orders these results based on a set of requirements or rules. These rules may be pre-defined as part of the matching engine (system-wide) or may be specified by the user as part of user input (per-user basis), or a combination. The rules basically specify how to determine if one result is preferred over another when compared. For example, a simple way to specify the rules is to give preference to a particular attribute of the resource or the calendar. Some consumers may give the most weight to a supplier's ranking when it comes to selecting a supplier. In this case, when the matching suppliers are presented to the consumer, they may be ordered based on supplier ranking, with the highest ranked suppliers in the front of the list. The consumer may specify preference for resources with Saturday availability, in which case resources that are available on Saturdays may be presented first. In some cases, this determination may involve a more complex formula with multiple requirements. For example, a user can assign a weight percentage to each attribute associated with the resource and the calculation is based on a combination of relevance and weight percentage of each match. This component plays a key role in proxy commitment in which the matching engine may engage users into a commitment automatically.

### XVI/ Flow Diagram

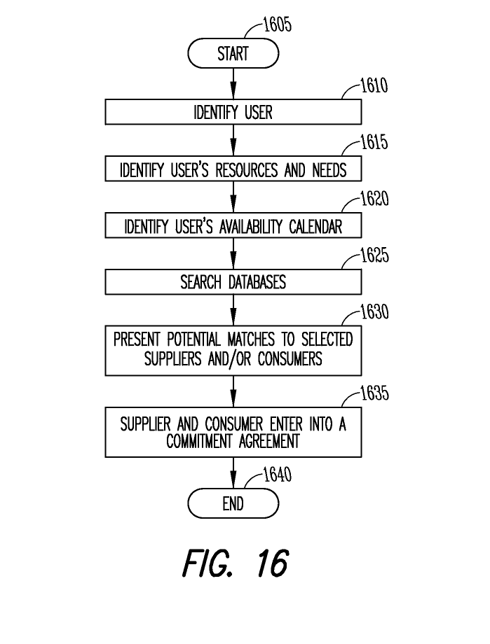

FIG. 16 is a flow diagram illustrating an example of a process that may be used by a matching engine to identify a potential match, in accordance with some example embodiments. The flow diagram may start at block 1605. At block 1610, a user may be identified. This may include the user logging into the matching engine. The user may be a consumer, a supplier, or both. At block 1615, information about the user's resources and needs may be identified. At block 1620, information about the user's calendar is identified.

At block 1625, the matching engine may search the databases to find one or more potential matches. For some example embodiments, the search may be automatically performed by the matching engine. For some example embodiments, the search may be initiated by the user. For some other embodiments, the search may be initiated by a consumer or initiated by both the consumers and the suppliers.

At block 1630, the matching engine may present the potential match or matches to the selected suppliers and/or the consumers. For some example embodiments, the matching engine may present the potential matches to the suppliers by sending a notification to the suppliers. The notification may be in the form of an email to an email address associated with the supplier. The email may be sent using any communication protocol and may be sent to any device associated with the suppliers. The device may be portable or non-portable and the communications may include wired or wireless communications. At block 1635, the supplier and the consumer may enter into an agreement. The process may end at block 1640.

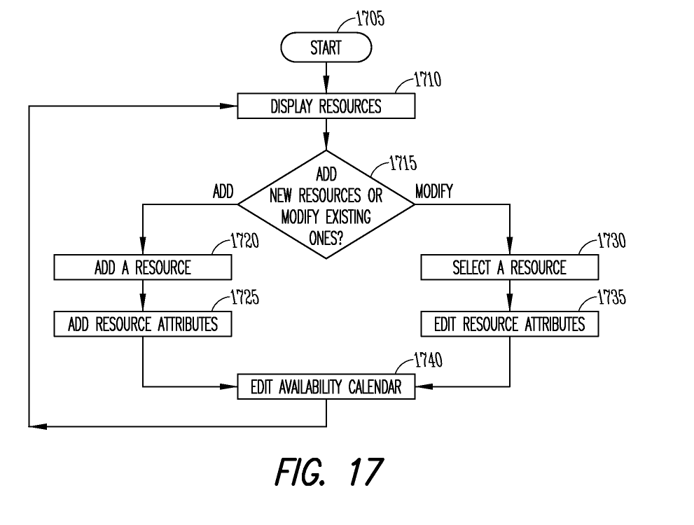

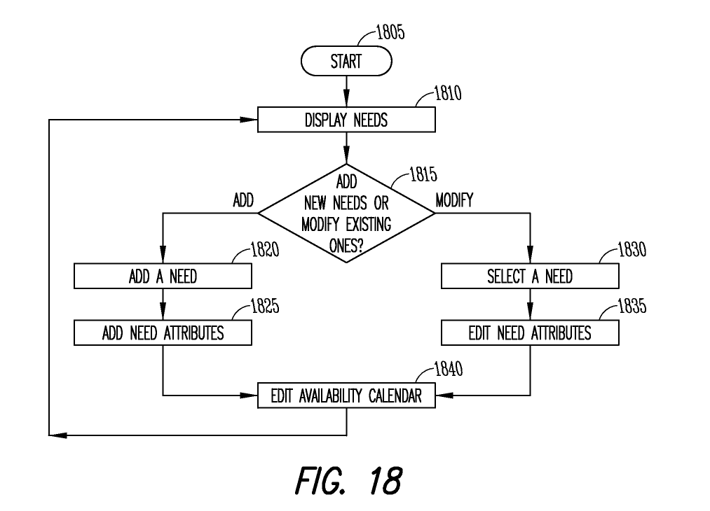

FIG. 17 illustrates an example of how the suppliers can manage their resources and calendar in the matching engine, in accordance with some example embodiments. The process may start at block 1705. At block 1710, the time-valued resources may be displayed. At block 1715, a test is performed to determine if the user wants to add new time-valued resources or to modify existing time-valued resources. If it is to add new time-valued resources, the process may continue to block 1720 where the new time-valued resource is added. At block 1725, the attributes are added. At block 1740, the calendar is updated.

From block 1715, if it is to modify existing time-valued resources, the process may flow to block 1730 where an existing time-valued resource is selected. At block 1735, the attributes of the selected time-valued resource may be edited. The process may then continue to block 1740. The process may end or it may repeat at block 1710.

FIG. 18 illustrates an example of how the consumers can manage their needs in the matching engine, in accordance with some example embodiments. The process may start at block 1805. At block 1810, the needs of a consumer may be displayed. At block 1815, a test is performed to determine if new needs are to be added or if an existing need may need to be modified. If new needs are to be added, the process may continue to block 1820, where the new need is added. At block 1825, the attributes are added. The process may then continue to block 1840 where the calendar is updated.

From block 1815, if an existing need is to be modified, the process may continue to block 1830, where the existing need is selected. At block 1835, the need is edited. The process then continues to block 1840. The process may end or it may repeat at block 1810.

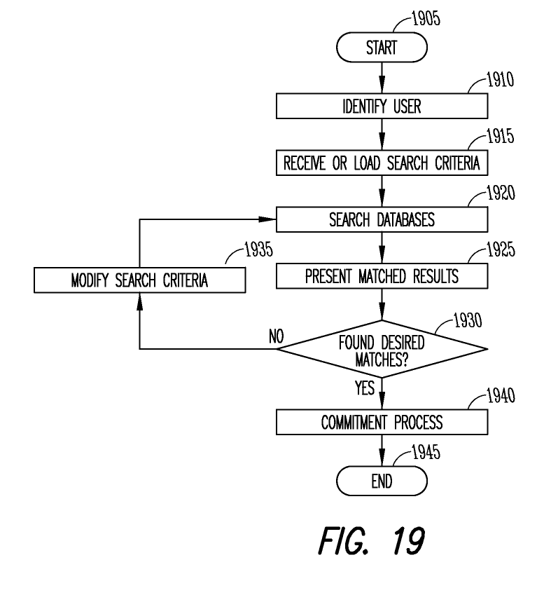

FIG. 19 a diagram that provides an example of how to perform a manual search in the matching engine, in accordance with some example embodiments. The process may start at block 1905. At block 1910, the user is identified. At block 1915, search criteria may be received or loaded. At block 1920, a search of the databases is performed. At block 1925, the search results are presented to the user. At block 1930, a test is performed to determine if desired matches are found. If none is found, the process may continue to block 1935 where the search criteria may be modified. The search may then be repeated at block 1920 if desired.

From block 1930, if the desired matches are found, the process may continue to block 1940 where a commitment process may be performed. The commitment process may vary depending on the time-valued resource that is being committed to. Some examples of this process include a mouse click to confirm, or make a payment if the time-valued resource has monetary value, or a process in which the supplier would make a proposal and it is up to the consumer to accept or reject, etc. The process of FIG. 19 may end at block 1945.

For some example embodiments, the matching engine may be configured to expand the panel concept described above to enable services to be brought together by a group of suppliers who may collectively solve a need of a consumer. For example, when a consumer has a particular need that may not be readily available, the matching engine may selectively form a group of suppliers or listings to collectively address the need or service that the consumer is looking for. A practical example of this service is a party planning service where multiple different services may be grouped together to address the needs associated with having a party.

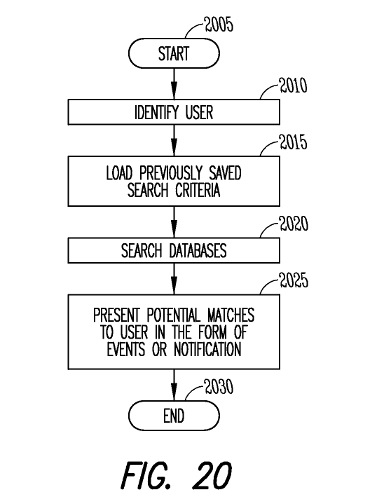

FIG. 20 shows an example of how the automatic search may work in the matching engine, in accordance with some example embodiments. The process may start at block 2005. At block 2010, the user is identified. At block 2015, previously saved search criteria may be loaded. At block 2020, the databases may be searched using the search criteria. At block 2025, the potential matches may be presented to the user. This may be in the form of events or notification. The process may be repeated for each user in the matching system that has enrolled in the automatic search. The process may end at block 2030.

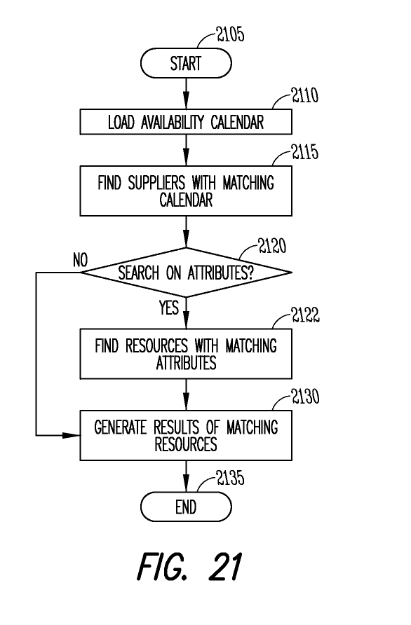

FIG. 21 illustrates an example of how to match a consumer to suppliers and resources, in accordance with some example embodiments. The process may start at block 2105. At block 2110, the calendar is loaded. At block 2115, searches for suppliers with matching calendar are performed and the suppliers are found. At block 2120, a test is performed to determine if search for attributes is necessary. If not, the process continues to block 2130, where the results of the matching time-valued resources are generated to present to the consumer and/or suppliers. From block 2120, if the attributes search is necessary, the process continues to block 2122, where the potential results may be narrowed by only those that have attribute matches. The process then flows to block 2130.

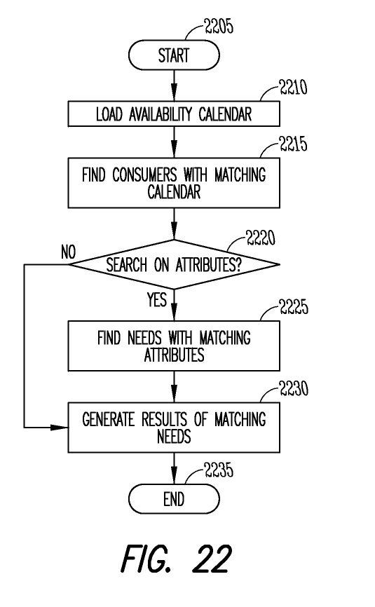

FIG. 22 illustrates an example of how to match a supplier to potential consumers with matching needs, in accordance with some example embodiments. The process may start at block 2205. At block 2210, the calendar is loaded. At block 2215, the matching system searches for consumers with matching calendars. It may be noted that in this situation, the consumers have previously enter their needs and calendar information. At block 2220, a test is performed to determine if searches need to be done on the attributes. If not, the process continues to block 2230, and the search results are generated for the matching needs. If the searches on attributes are necessary, the process flows from block 2220 to block 2225, and the attributes searches are performed before moving to block 2230. The process may end at block 2235.

It may be noted that some of the operations described in process illustrated in FIGS. 16-23 may be performed in an order that is different from the order depicted. The order, however, does not deviate from the novel features of the concepts being conveyed.

### XVII/ Transaction Processing for Time-Valued Resources and Rental Marketplace

For some example embodiments, the matching system may be configured to manage an agreement such that a complete transaction is facilitated between the supplier and consumer. There may be a hierarchical organization of account, asset, and resource (service). An account may represent a contract between an individual or an organization and the matching system (or a marketplace manager, a marketplace facilitator, marketplace organizing company, marketplace organizer, etc.). An account holder may be an individual or an organization that has account or is registered with the matching system. An account holder may be a consumer, a supplier, or both.

The matching system may be an environment for accountability and responsibility on part of an account holder. The matching system may accept and manage multiple accounts. An account holder may have an account which may have one or more assets, where each asset may further have one of more time-valued resources. Each account holder may be capable of offering to supply multiple time-valued resources, offering to consume multiple time-valued resources, or both offering to supply multiple time-valued resources and offering to consume the same or a different multiple time-valued resources.

An account holder acting as a supplier may publish a listing of resources or services available for supply. The publishing of a listing does not imply that a supply is or will be contracted for supply resulting in an agreement. An account holder acting as a consumer may publish a listing of need in the matching system. The listing itself may not imply that a need is or will be contracted for satisfaction resulting in an agreement. Once there is a potential match of a time-valued resource from an account holder acting as a supplier and an account holder acting as a consumer for a time-valued resource, a commitment may be created.

A commitment may be temporary and may allow time for the potential supplier and the potential consumer to find out more about each other and about any additional requirements associated with the potential match, or to negotiate more details before having a formal agreement. During this time, the status of the affected time slot or time slots may be pending. There may be factors that cause a potential supplier or a potential consumer to back out of a commitment. For example, the consumer may not like the quality of the time-valued resource offered by the supplier.

When there is an agreement, the matching system may manage various aspects of the agreement from inception to completion. This may include forming an escrow account, resolving dispute, managing early termination, processing payment, etc.

The timed-value resources may be hard good such as a bicycle, a property, DVD, video game, chain saw, copier, network connected printer capable of printing multiple identifiable print jobs, etc. The time-valued resource may be a service that may include service for hard goods. A service for hard goods may be “rental”, or in cases of property, may be simultaneously used in multiple ways with the “rental” of each uniquely identified simultaneous occurrence. Examples of a property may include, but are not limited to vacation home, rental home, multiple apartments in one building/complex, hotel rooms within one hotel or resort, various identifiable locations on a website where advertising content may be displayed, a billboard where advertising may be displayed, a garage with multiple stalls for automobile storage, etc. A service of an account holder or holders may include, but is not limited to, for example, work completed, imparting of knowledge, tutoring, lessons, tours, research, performed art (comedy, music, theatrical), or other intangible service offered by an account holder, an enterprise or an organization.

For some example embodiments, the matching system may be implemented as a marketplace that enables renting of idle assets (or time-valued resources) to generate revenues for owners/sellers (or suppliers) in non-business settings. It may be noted that the rental marketplace implemented with the matching system (referred to herein as a rental matching system) may be different from the typical rental marketplace in that each of the time-valued resources listed in the rental matching system may be time driven, and any owner/seller controlling a time-valued resource may participate or rent their assets or publish their rental listings with the rental matching system.

The rental matching system described herein may be implemented in any environment or community of any scale to enable utilization of idle time-valued resources. For example, a rental matching system may be implemented for a community that may include a neighborhood, students at a school, members of a parent teacher association (PTA), members of a beer making club, etc. The rental matching system may be used to raise revenue for the owners of the time-valued resources, to raise revenue to support a social cause, to share equipments, to share video games, to offset cost of an expensive equipment, etc. As such, the rental matching system may make more time-valued resources available for usage when most of these time-valued resources may not be available in the traditional rental marketplace.

For some example embodiments, the rental matching system may be configured to store information about the different rental communities that are set up by the account holders worldwide. The rental matching system may then suggest a rental community to a consumer who is searching for a time-valued resource. The suggestion may be based on the geographical location where the consumer resides and the geographical locations where the rental communities exist. For example, a consumer searching for a tennis instructor in the city where he lives may not realize that a member of the local school PTA is also a tennis instructor. By suggesting that the consumer checking out the PTA rental community, the matching system may achieve its purpose of helping its account holders optimizing utilization of their time-valued resources.

### XVIII/ Modes of Delivery

When there is an agreement between a consumer and a supplier, the time-valued resource may be delivered from the supplier to the consumer using various delivery modes including, for example, online, offline, or a hybrid of both online and offline. A time-valued resource may be delivered online, offline, or through the hybrid mode. For some example embodiments, when a time-valued resource is delivered online, the matching system may be equipped to provide online presence information of both the consumer and the supplier to each other. A consumer and supplier exchange the purchased/contracted time-valued resource wherein the purchased time-valued resource may be delivered from the supplier to the consumer using either an online, offline or hybrid mode. It may be useful to note that a delivery may be either one-way or collaborative. A one-way delivery may be a classroom type of presentation or a pre-recorded presentation. A collaborative delivery may be designed for interaction between consumers and suppliers.

The online delivery mode may include the actual delivery of the service rendered through the Internet using a variety of tools. These tools include audio, video, chat (IM), Voice over Internet Protocol (VoIP), screen sharing, white boarding, phone connectivity between the parties using a combination of traditional analog and digital technologies. This collaboration environment for delivering the time-valued resource may also be augmented with a variety of productivity tools like calendaring, task management, taking notes on the delivery of the time-valued resource, recording data associated with the delivery of the time-valued resource and monetization.

The offline delivery mode may involve meeting in person or the physical delivery of a time-valued resource. An example of this may include delivering a lesson during a selected time slot. The lesson may be a tennis lesson delivered by a tennis instructor at a tennis court.

The hybrid delivery mode may include a combination of online and offline delivery modes. For example, it may include a variety of online tools in addition to meeting in person for delivering a time-valued resource.

The delivery of the time-valued resource may be either scheduled or immediate. A scheduled delivery may involve an agreement between a consumer and a supplier to a given calendar date and time slot, whereupon the time-valued resource may be delivered. An immediate service delivery involves the supplier delivering the bought service immediately to the consumer. It is noted that the timing of delivery may be applicable to all modes of delivery mentioned above.

### XIX/ Transaction Phases

The matching system may facilitate an environment where a large number of participants may exchange time-valued resources in a competitive environment, potentially resulting in a liquid marketplace. There may be multiple transaction phases that may take place in the marketplace. These phases may include, for example, offering phase, pending phase, contracted phase, delivery phase, feedback collection phase, dispute resolution phase, and closure phase.

In the offering phase, an available timed-valued resource from a supplier may be listed and published by the matching system. This may result in a published listing. In the pending phase, one or more consumers may have expressed an interest in a published listing. The contracted phase may represent the period of time that elapses between a time when an agreement is completed and a time when the delivery of the time-valued resource is completed or consumed. The delivery phase may represent the period of time when the service is being provided. The feedback collection phase may represent a time period during which the feedback is collected from a consumer and a supplier. The dispute resolution phase may include an event when there is a dispute raised by either a consumer or a supplier. The closure phase may be the time period or a point in time when the transaction is complete.

For some example embodiments, the matching system may be configured to resolve disputes when a consumer and a supplier do not agree on the satisfactory completion of a transaction. The matching system may collect and report the dispute history of a user. For some embodiment, a dispute history may be collected and become part of the attributes of a time-valued resource. This may enable avoiding the users who may frequently involve in disputes. For some example embodiments, the matching system may use an escrow account to hold funds such that a potential dispute may be enforced.

### XX/ Monetization

The matching system described may not necessarily involve monetary payment. For example, the matching system may enable employees of a company to utilize availability of multiple conference rooms.

For some example embodiments, the matching system may allow consumers to receive needed time valued resource at a favorable cost in a competitive marketplace for one or more of the consumers' needs for the time-valued resources. The consumers may involve in transactions that may take place by a number of purchasing methods, exemplified below. For some example embodiments of a monetary transaction, a specific “Purchasing” phase for handling the transaction may be inserted between “Pending” and “Contracted”. In these situations, the transaction between a supplier and a consumer may include a phase that facilitates monetary exchange.

For some example embodiments, the matching system may be used to generate monetary revenue for the time-valued resources. In some situations, the monetary revenue may be gained as a result of a managed agreement. In some situations, the monetary revenue may be gained as a result of some other types of agreement related to the matched agreement.

An agreement may evolve into a transaction that involves monetary exchange. The matching system may be implemented as a competitive marketplace, in which the time-valued resources may be traded for a market-driven value balance between one or more consumers of time-valued resources and one or more suppliers of time-valued resources. In these situations, the matching system may enable suppliers to generate monetary revenue (e.g., selling) by offering and providing the service of one or more time-valued resources.

For some example embodiments, the matching system may implement context-sensitive advertisement for a given service or listing. This may enable the matching system to deliver more options or services to the consumers or to any other users of the matching system. Furthermore, having the context-sensitive advertisements may help provide additional funds for the matching system facilitator and for the suppliers/sellers. The suppliers/sellers may then be able to discount their services due to the additional revenue coming from the advertisements.

### XXI/ Pricing/Auction Transactions

There may be different pricing models that may be implemented with the matching system. In a fixed price model, the matching system may allow a consumer to simply purchase an offered/available time-valued resource for a price that may be stated in the listing. There may be no opportunity for competitive price adjustment in this model, and the offer may be closed upon purchase. When using an auction model, the consumer and the supplier may be able to get more competitive pricing for the time-valued resources. There may be various auction models, and they may be combined with other pricing models to enable the matching system to offer multiple combinations of pricing models for the consumer and the supplier to bid.

In a forward auction model, the matching system may allow a consumer to bid in a competitive environment against other consumers, for an offered time-valued resource at a price that is adjusted according to the highest bidder. In this model, the supplier may have the ability to set a low acceptable price, either as a start price, or as a hidden reserve price. The offer may remain open until the auction terminates at the prescribed time.

In a fixed price with roll to forward auction model, the matching system may allow a consumer to simply purchase an offered resource for a fixed price that may stated in the offering, until a consumer places a competitive bid that may be lower than the listed purchase price. Once the bidding starts, the listed fixed purchase price may be eliminated, and the auction may be allowed to run to completion. In this model, a consumer may get the item at a price lower than the listed price, but it is also possible the price will be driven up by competition above the initial listed price. If the purchase is made during the time the fixed price is still available, then the offer may be closed, otherwise the offer may run until the prescribed end time.

In a forward auction with fixed price model, the matching system may allow a consumer to simply purchase an offered resource for a fixed price that may state in the offering, or attempt to place a competitive bid that may be lower than the fixed purchase price. Once the bidding starts, the fixed purchase price may remain available until the auction ends. The auction may end prematurely when a fixed price offer is placed, or run to completion at the prescribed end time. In this model, a consumer may get the item at a price lower than the listed fixed price.

In a reverse auction (with fixed price) model, the matching system may allow a consumer to place requests or list needs for one or more resources (as opposed to offered resources in forward auctions), where the listing for the request may indicate one or more of the following: a maximum price; a fixed price (minimum price); a prescribed end time. In this case, suppliers interested in offering the requested time-valued resource may make an offer to the consumer by placing a competitive bid at the maximum price or a lower price. In the event an offer is placed with the fixed price, the auction may end prematurely; otherwise the auction may end at the prescribed time where the lowest priced bid may be the winner and the bid may be binding.

In a forward auction with roll to reverse auction model, the matching system may monitor the activity of an account and provides guidance to the account holder, giving the opportunity to convert a given forward auction into a reverse auction. When so configured, the matching system may automatically convert a given forward auction into a reverse auction, when certain criteria are met.

In a multiple simultaneous uses, multiple consumers may be allowed to purchase the same resource at a given time slot. This type of offering is known as a one-to-many (event) transaction. Multiple uses may be allowed in all purchase models except the reverse auction model.

In an automatic auction model, the matching system may conduct an automatic sale or purchase, without the manual intervention of the consumer or the supplier, within certain specified criteria, where the optimal value for the offering may be determined by the process of analysis.

For some example embodiments, the matching system may manage the biddings until a time when a price is determined. The matching system may then notify the supplier and the consumer to enable them to move into the next phase of the transaction (e.g., pending phase and agreement phase).

### XXII/ Payment Handling

For some example embodiments that facilitate monetization, the matching system may enable the suppliers in an agreement to collect payments. The matching system may be capable of collecting payment from a consumer for planned consumption of time-valued resources to be consumed by the consumer, or consumed by an assigned designee on behalf of the consumer. The matching system may be capable of payment to a supplier for consumed time-valued resources provided by the supplier, or provided by an assigned designee on behalf of the supplier.

For some example embodiments, the matching system may be capable of holding funds in escrow, upon receiving funds from a consumer after a transaction is agreed, and until the transaction is identified by the consumer and the supplier as completed with satisfaction, prior to releasing funds to the supplier. The matching system may be capable of resolving escrow accounts in the event a transaction is identified as unsatisfactory, and said transaction is resolved through the dispute resolution process.

For some example embodiments, the matching system may engage a service of a third party escrow company to hold the funds in escrow and to release the funds to the supplier at the appropriate time.

### XXIII/ Promoting the Marketplace

The matching system may be used to implement a competitive marketplace for time-valued resources from suppliers and consumers. In these implementations, there may be a need to increase the liquidity of the time-valued resources through promotion of the marketplace in various ways.

For some example embodiments, the promotion of the marketplace may involve many participants using a competitive bidding process. The matching system may collect and publish relevant confidence level information about the consumers and the suppliers for the purpose of creating increased competition and differentiation, hence, working to enhance value of the timed-valued assets.

The matching system may collect rating information as a result of a delivered transaction between the consumers and the suppliers. The rating information may be collected about a consumer from a supplier on a per-transaction (or per-commitment) basis. The matching system may include a ranking system that incorporates the rating information, as well as, the historical knowledge of past transactions (commitments) and other related performance metrics to provide a confidence level.

For some example embodiments, the rating, ranking, and confidence levels may be an integral part of the marketplace to offer higher value for those consumers or suppliers who demonstrate a higher ranking, rating, and confidence level. The rating, ranking, and confidence levels may be assigned to all consumers and suppliers who participate in the marketplace. The rating, ranking, and confidence levels may be assigned to all time-valued resources (tangible, non-tangible, or hybrid) of a consumer or a supplier.

For some example embodiments, detailed historical data may be collected and reported for rating, ranking, and confidence levels. The historical data may be consolidated by type of data, by account, by asset, by service (resource), by date ranges, by various combinations of these, and other useful measures or combinations thereof. For some example embodiments, the historical data may be collected and reported for the level of donations made by the consumers and the suppliers to social causes (described below). The level of donation may be an integral part of the ranking/rating system, and may be presented along with the other performance information when the account of a consumer or of a supplier is viewed.

### XXIV/ Promoting the Account Holders

For some example embodiments, the matching system may be configured to enable promotion of the consumers, the suppliers, resources of an account, services of an account, etc. The promotion may include, but is not limited to featuring the promoted entity in the marketplace (e.g., Web site of the matching marketplace facilitator or manager), listing the promoted entity in a more prominent order when the matching system lists available services.

The criteria for promoting an account and time-valued resources may include, but are not limited to levels of donation accrued for the account, asset, or service, ranking/rating/confidence levels of the account, asset, or service, and activity (number of transactions) of an account, asset, or service.

### XXV/ Approved and Disapproved Lists

For some example embodiments, the matching system may enable an account holder to create a list of approved consumers or buyers (Approved Buyer List—ABL) and a separate list of approved suppliers or sellers (Approved Seller List—ASL). The account holder may be allowed to make entries in the separate lists only at the end of a transaction. If the account holder is a supplier in a given transaction, then the account holder may make an entry in the approved buyer list for that transaction such that the buyer is listed. If the account holder is a buyer in a given transaction, then the account holder may make an entry in the approved seller list for that transaction such that the buyer is listed.

The matching system may be configured to enable users to create a list of disapproved consumers or buyers (Disapproved Buyer List—DBL), and a list of disapproved suppliers or sellers (Disapproved Seller List—DSL). The account holder may be allowed to make entries in the DBL or the DSL only at the end of a transaction. If the account holder was a supplier for a given transaction, then the account holder may make an entry in the DBL for that transaction such that the consumer/buyer is listed. If the account holder is a buyer for a given transaction, then the account holder may make an entry in the ASL for that transaction such that the supplier/seller is listed.

### XXVI/ Circle of Friends

The matching system may be configured to enable an account holder to make a list of other accounts to form a peer user group, or circle of friends. The account holder may have the option to publish the ABL, the ASL, or both to the circle of friends. Further, the account holder may also have the option to allow friends of friends to view the ABL, ASL, DBL, DSL, or any combination of these. When enabled, the complete set of accounts in the circle of friends of each account listed in the current account's circle of friends is allowed to view the current account's ABL, ASL, DBL, DSL, or any combination of these.

### XXVII/ Donation to Social Cause

For some example embodiments, the matching system may encourage account holders to make donations to social causes. The matching system may collect the donations. The effect of the donation to the social causes may include driving a higher level of donation through the use of peer pressure. The matching system may be configured to drive both a breadth of social causes (e.g., many social causes), and higher levels of donations (e.g., large monetary amounts).

The social cause may be a legitimate 501c3 non-profit charitable organization (if within the United States) or other appropriate non-profit charitable organization recognized accordingly in the country of origin of the organization. Any rules or regulations required by law will be used to establish the details of the social cause function of the matching system.

An account holder may make a donation to one or more specific social causes. There may different donating methods including, for example, giving funds directly, giving via percentage of earnings, giving indirectly through a service that is donated (e.g., when a consumer pays for a service, a proceeds of that sale is donated to a social cause).

When the donations are made to more than one social cause, the account holder may select the percentage breakdown of donations among the specified social causes. These percentages may be defined as a default for the account and then modified on a per-transaction basis.

For some example embodiments, statistics and detailed history of donations may be kept on a per-account and per-social cause basis. This information may be used in establishing the level of donations for each account. This information may also be used in establishing the level of donation received by a social cause, which is presented to the account holder community in various aspects of the system including, for example, listing of top ten social causes by funds donated to the cause, listing of top ten social causes by number of donations to the cause, randomly featured social cause, etc.

From time to time, the matching system may promote one or more social causes, based on current events or other criteria. In such a case, the matching system facilitating company may opt to supplement donations to one or more causes, thus, fueling donations from active participant account holders.

### XXVIII/ Cross Advertisement

For some example embodiments, the matching system may be configured to promote other relevant goods that pertain to the given service or resources being examined or delivered. The matching system may cross selling goods of value to a consumer that is related to the service being delivered by a supplier. This may give additional revenue stream to the matching system facilitating company (e.g., the marketplace operator or manager). This form of cross advertisement by the matching system may be based on intelligence or gathered historical data to determine what is most likely needed for a given service or time-valued resource.

### XXIX/ Example Object Diagram

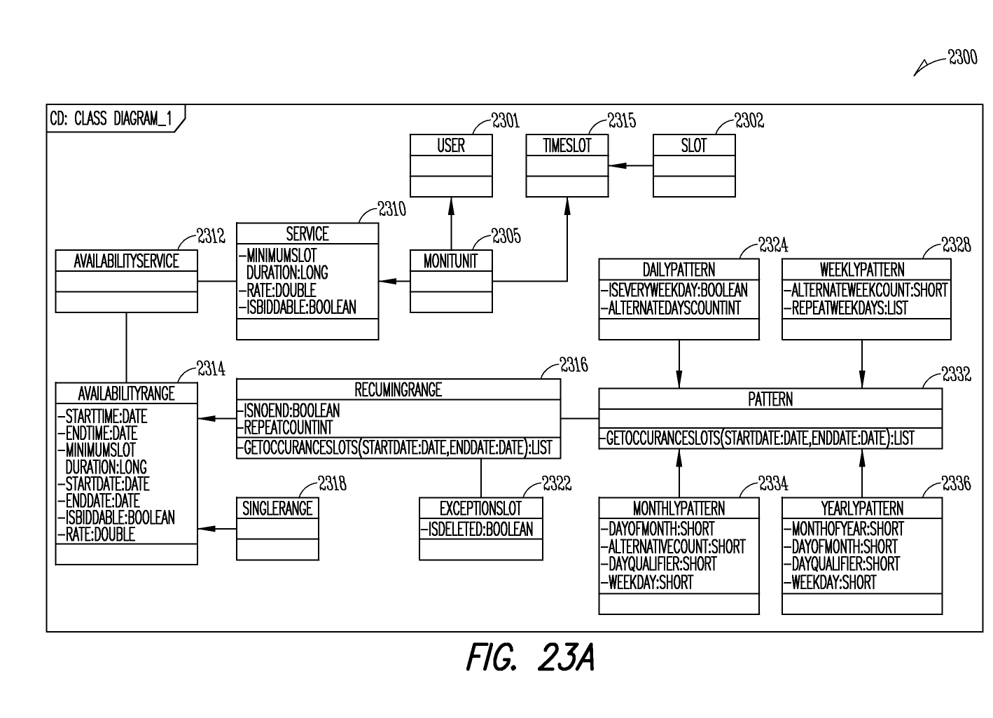

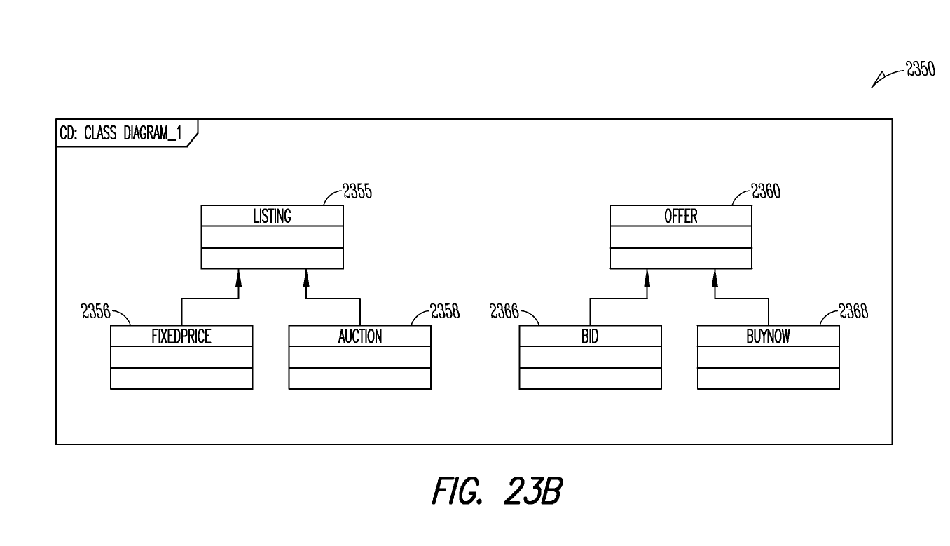

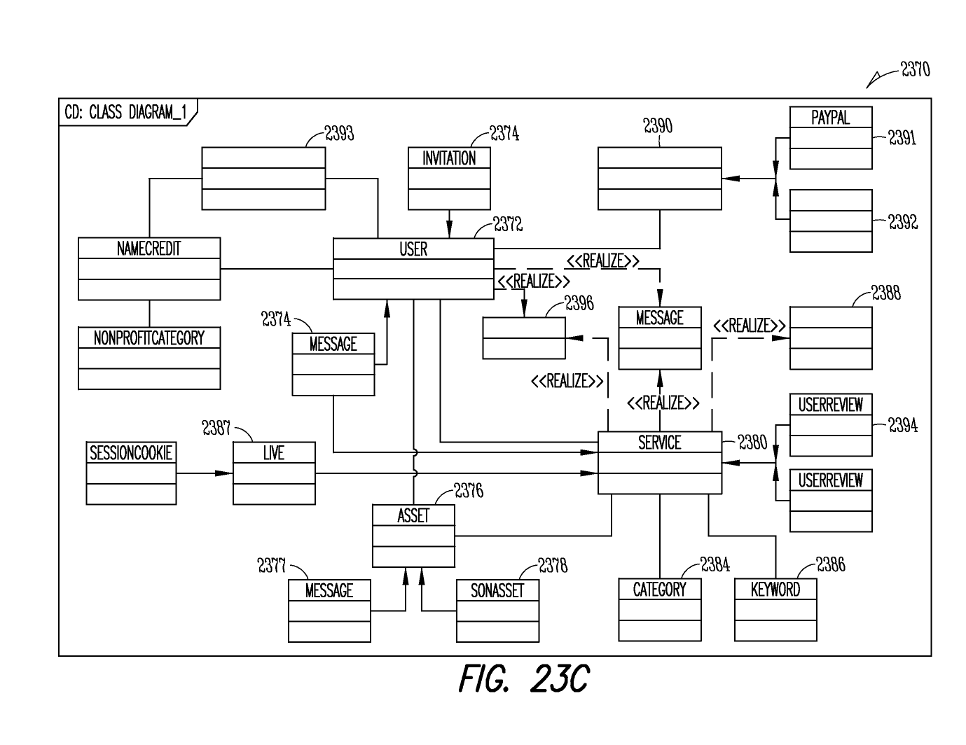

FIGS. 23A-23C illustrates examples of object diagrams that may be used with a matching system, in accordance with some example embodiments.

The diagram in FIG. 23A illustrates an example for the objects representing the listing of a resource and the associated availability calendar. Diagram 2300 illustrates the listing of the resource as a service 2310 that is associated with a user 2301. Whenever a buyer purchases a timeslot 2315 for the service 2310, a monetary unit 2305 (referred to in the diagram as MonitUnit) is created. The MonitUnit 2305 has links to the service 2310 and the time slot object 2315 that was created to represent the time slot that was purchased. The service object 2310 also has an availability specification 2312 associated with it. The availability specification 2312 may be associated with availability range 2314 and all other objects connected to it directly or indirectly, as illustrated in FIG. 23A.

The diagram 2300 illustrates one method for arranging the availability specification that comprises of various elements including ranges of dates/times, recurrences, and exceptions. In this example, the availability may consist of an AvailabilityRange 2314, which specifies a range of time in a 24-hour day with a start time and an end time, plus either a SingleRange 2318, if the AvailabilityRange 2314 is a one-time occurrence on a specific date, or a RecurringRange 2316, if the same AvailabilityRange 2314 is to repeat over a period of time. The RecurringRange 2316 is defined in a Pattern 2332 that may repeat daily 2324, weekly 2325, monthly 2334 or yearly 2336. It may also have a specification of exceptions to the range as specific time slots.

FIG. 23B illustrates an example of objects representing the listing of a resource by a supplier or an offer to acquire a resource by a consumer within the marketplace. In this example, the listing 2355 shows either a fixed price 2356 or auction style price 2358, or both. The offer 2360 shows either the elements of a bid price 2366 (if the Auction is enabled for a resource Listing to which the Offer will be associated), or a BuyNow element 2368 (if the FixedPrice is enabled for a resource Listing to which the Offer will associated), or both.

FIG. 23C illustrates an example of objects that may be required for the marketplace to be fully operational. Diagram 2370 includes objects that are involved in the management of user accounts, handling resources as service listings, monetary transactions, social cause support through donations, and user feedbacks. The key element in this marketplace example is the user 2372. The user 2372 may join the system through an invitation 2374 from another user or from the system. A user 2372 may receive messages 2374 from other users or the system. Examples of messages 2374 include questions/answers from other users and notifications from the system.

A user 2372 may have assets 2376 for which they can offer services 2380. In this example the asset 2376 is described as being either a HardAsset 2377 or a SoftAsset 2378, as these may have different behaviors. The HardAssets 2377 may be more suited for rental and may have specific configuration parameters for the service offered for such assets; The SoftAssets 2378 may be intangible skills and the services offered may be skills, work effort, lessons, etc. and may have different configuration parameters. When listing a service 2380, the user 2372 may associate it with a category 2384 and a number of keywords 2386. So consumers may browse through the system by narrowing down to a specific category 2384 or a specify keyword 2386. A service 2380 may become a “Live Service” 2387 when the supplier logins to the system and makes an indication of being available for Live service. It means the supplier is able to provide instant service without advanced scheduling. A Service may be Watchable 2388 so consumers can create a “watchlist” of their favorite services.

A user 2372 may specify different ways to pay for services 2380 they wish to purchase, which is represented here as a PaymentMethod 2390. Examples of PaymentMethod include PayPal 2391 and CreditCard 2392. A User 2372 can support a social cause or a NonProfit through Donations 2393. Donations can be automatically deducted from the proceeds of a monetary transaction. In this proposed marketplace, users 2372 involved in a transaction may review each other's performance and provide feedback. This information is captured in the UserReview object 2394. Both user 2372 and service 2380 may be reviewed (hence they are both Reviewable 2396). For example, the consumer may review the supplier for service performance, and the supplier may review the consumer for promptness. Both user 2372 and service 2380 are viewable objects since they can both show up as search results.

### XXX/ User Interface

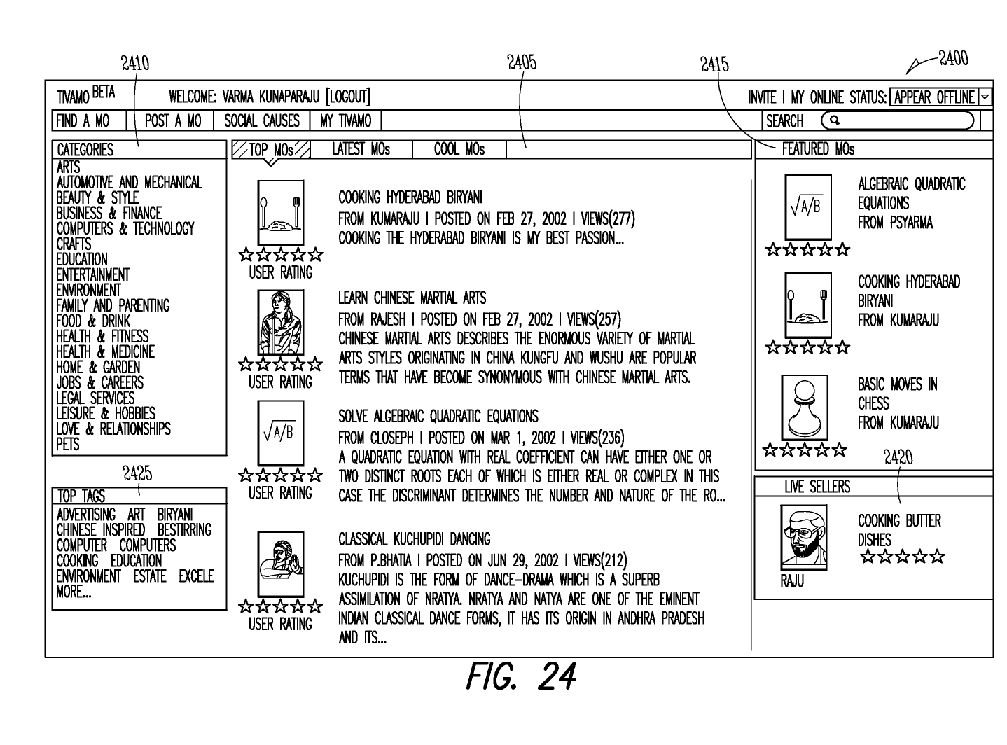

FIGS. 24-41 illustrate examples of interfaces of the matching system that may be used by a consumer or a supplier, in accordance with some example embodiments.

FIG. 24 illustrates an example interface 2400 of the matching system listing the time-valued resources. Each of the listings of the time-valued resources is referred to as an MO (or monetary unit). The interface 2400 may include top MOs, latest MOs, and cool MOs display area 2405. The display area 2405 may display related information selectable by a user using selectors such as tabs. For example, the display area 2405 includes a Top MOs tab, a Latest MOs tab, and a Cool MOs tab. The interface 2400 includes a featured MO display area 2415 that may be reserved for suppliers who want to pay to the matching system facilitator to advertise their listings or to highlight ongoing promotions. Other display areas include categories display area 2410 to display the different categories that the listings may be classified or categorized under, display area 2425 to display the top tags or recently used top keywords, and display area 2420 to display live sellers to enable the potential consumers to communicate with the sellers using, for example, a chat interface.

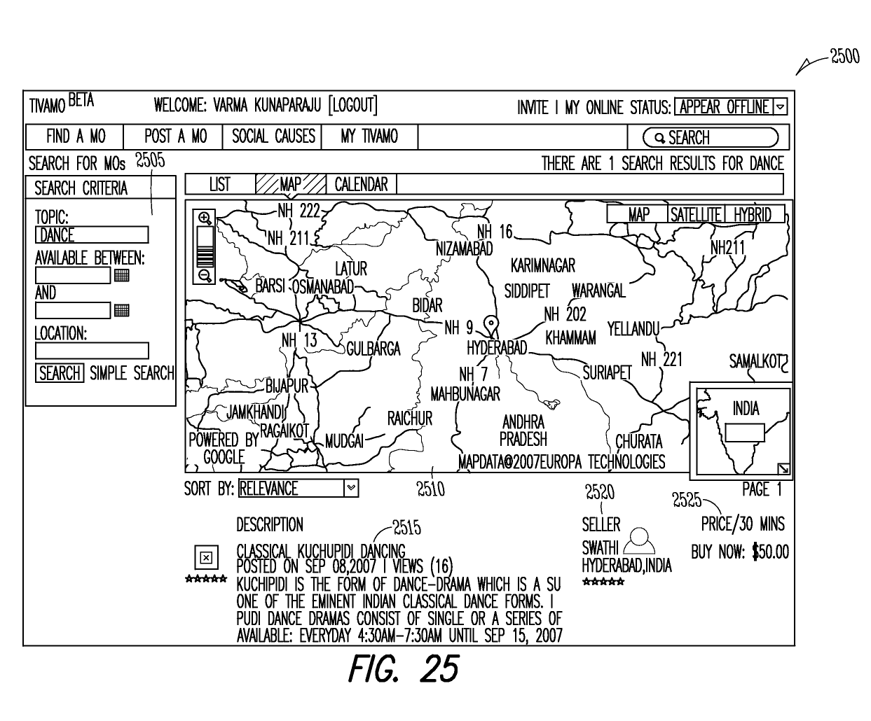

FIG. 25 illustrates an example map interface 2500 that may be used to search for MOs. The map user interface 2500 may include a search area 2505 to enter search parameters to search for a resource (MO). The search parameters may include topic information, time slot information, and location information. The map interface 2500 may also include a map area 2510 to geographically display a local map and highlighting a location associated with an available resource or a listing. The map area 2510 may also include a subarea that displays a corresponding regional map. In the current example, the map interface 2500 includes information about a supplier/seller 2500, the rating of the supplier/seller 2500, the description of the time-valued resource/service 2515, and the price information 2525.

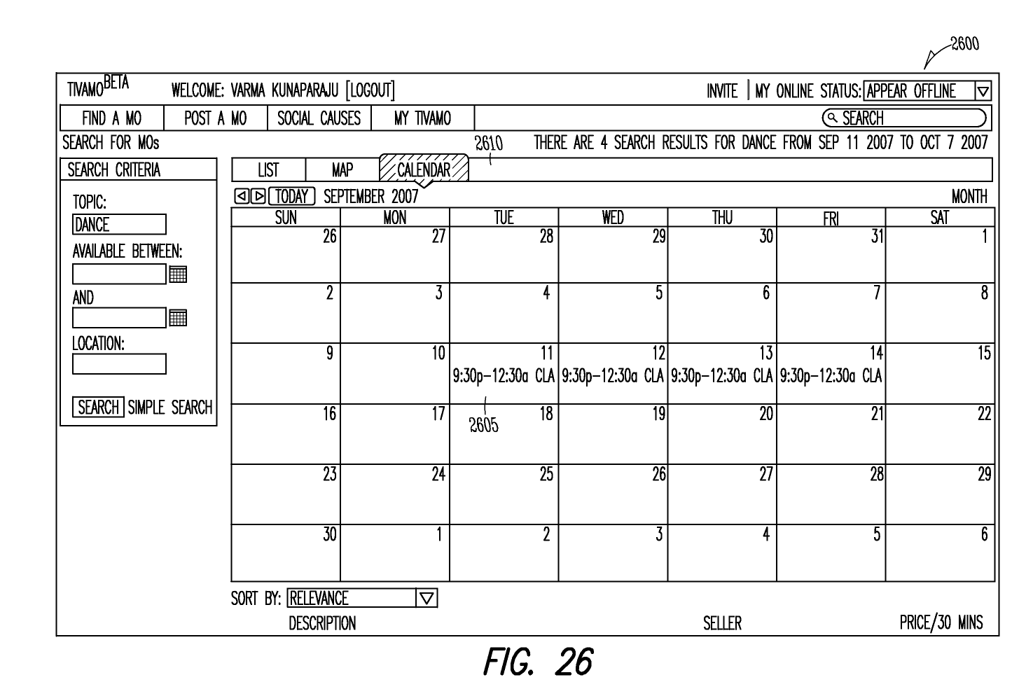

FIG. 26 illustrates an example of a calendar interface 2600 that may be used to display search results. The calendar interface 2600 may the search results directly into a calendar days that correspond to the days the related resources are available. For example, the calendar interface 2600 displays four search results for dance in the day area 2605. It may be noted that the calendar interface 2600 may be activated by using a calendar selector or tab 2610. Other available tabs may include a list selector and a map selector.

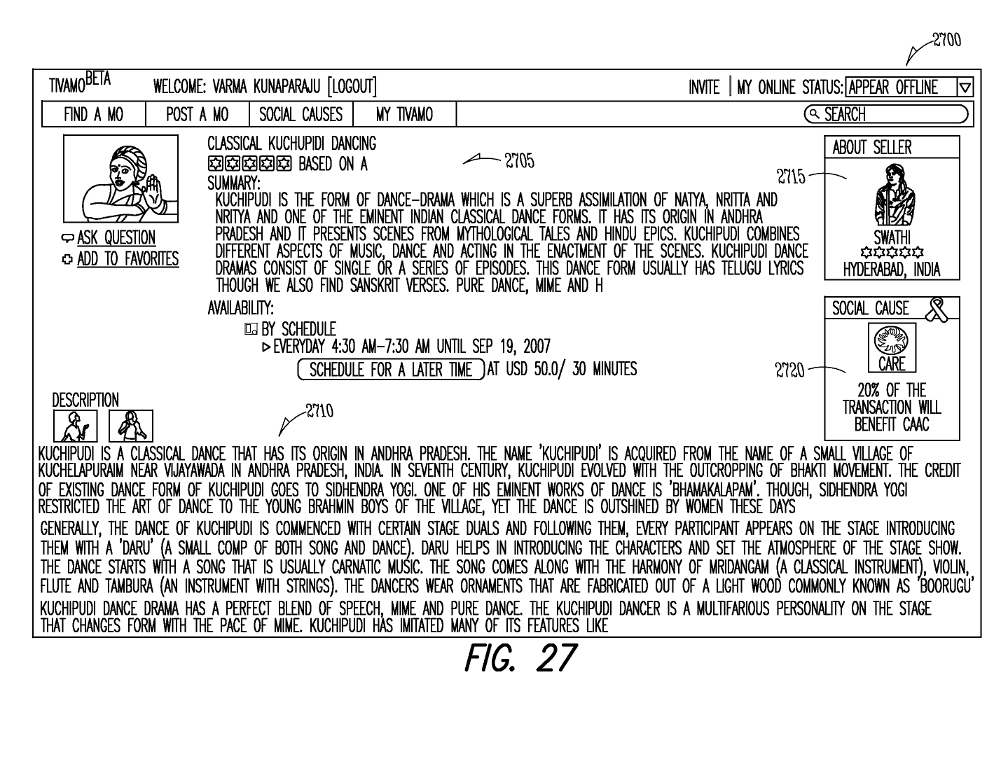

FIG. 27 illustrates an example of a listing interface 2700. The listing interface 2700 includes a summary display area 2705 to display summary information including availability information of a listing, detailed display area 2710 to display detailed information including description information and any graphics about a listing, seller/supplier information area 2715 to display information about the seller/supplier including rating information, nickname or user identifier, location, etc. When the supplier/seller may also be associated with an avatar (described below), the avatar may also be displayed in the seller/supplier information area 2715. There may also be a social cause area 2720 to display information about the seller's participation in any social causes. For example, the social cause area 2720 may indicate that the seller will donate a certain percentage of the proceeds from the transaction to a particular social cause organization.

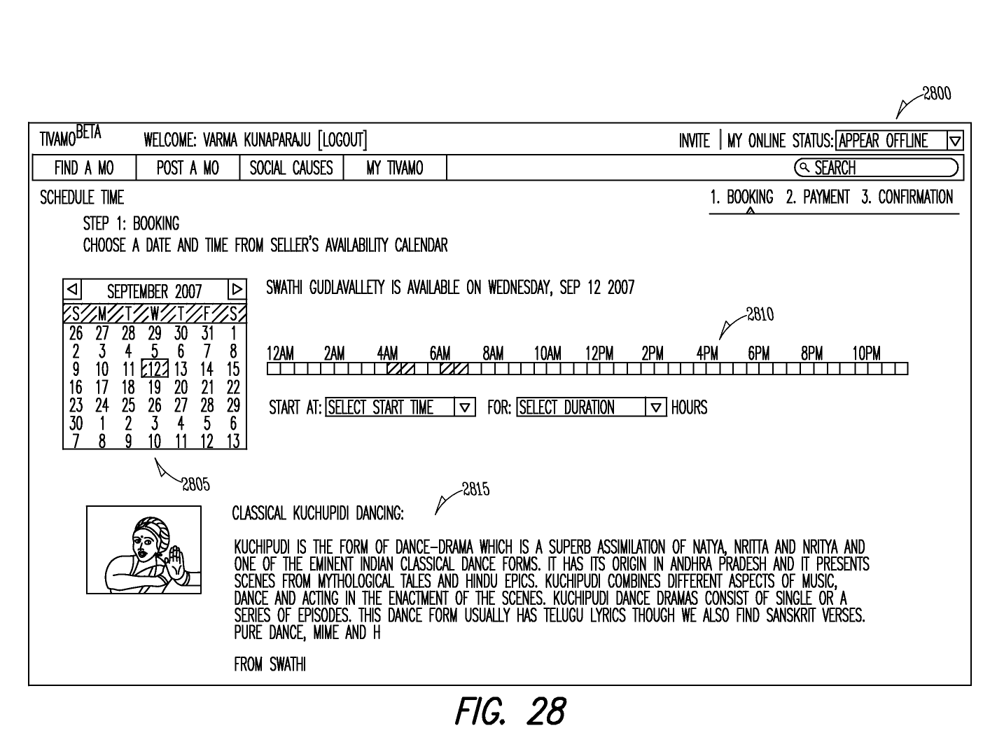

FIG. 28 illustrates an example of a booking interface 2800. The booking interface 2800 includes a display of a calendar 2805, a display of a time line 2810 in a given calendar day, and a resource description area 2815. Note that the booking interface 2800 in this example illustrates a calendar of a supplier/seller. A consumer may use the booking interface 2800 to find out when the supplier/seller may be available to offer the service described in the description area 2815. The consumer may select a day, a start time, and duration for the delivery of the resource. Note that the calendar 2805 may be interactive, which means the consumer may choose any day or any month by selecting the appropriate day or month selector. Once the consumer finds a day and time that the consumer wants to select, the matching system may navigate the consumer from the booking interface 2800 to a payment interface.

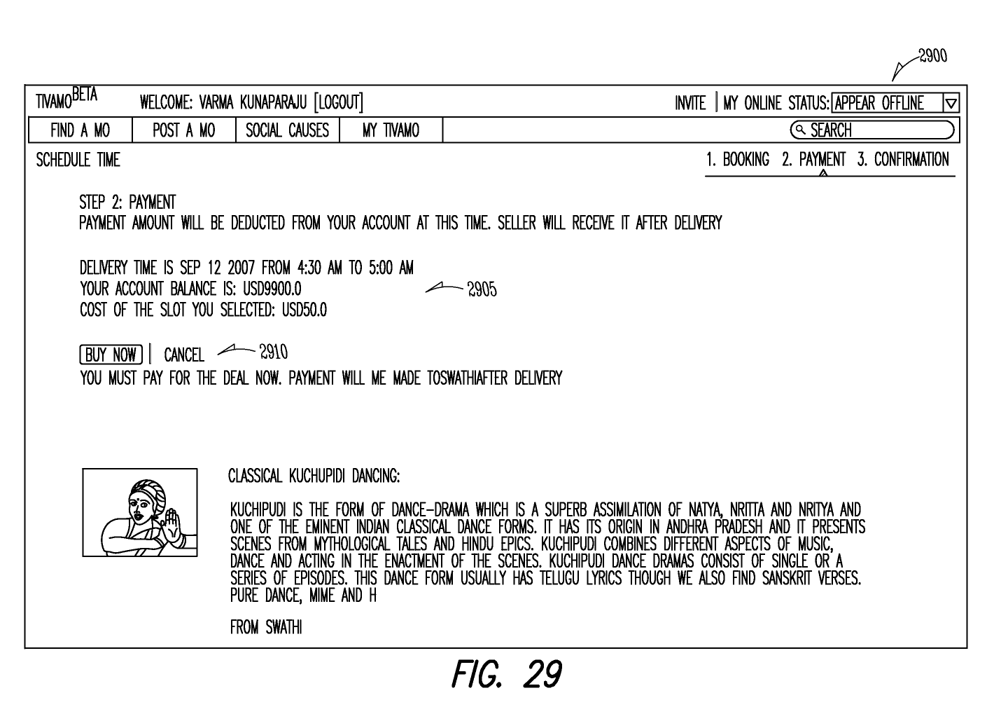

FIG. 29 illustrates an example of a payment interface 2900. The payment interface 2900 may be presented to the consumer to enable the consumer to review the details about the time-valued resource that the consumer is committed to. The payment interface 2900 may include a payment information area 2905 to display information about the cost of the time-valued resource and the associated time slot. The payment information area 2900 may also include information about the consumer's current balance in situations when the consumer has an outstanding balance or account with the matching system facilitator. When the information is verified and the consumer decides to go forward with the transaction, the consumer may select a buy selector in the purchase area 2910. Alternatively, the consumer may also cancel the transaction by selecting the “cancel” selector in the purchase area 2910.

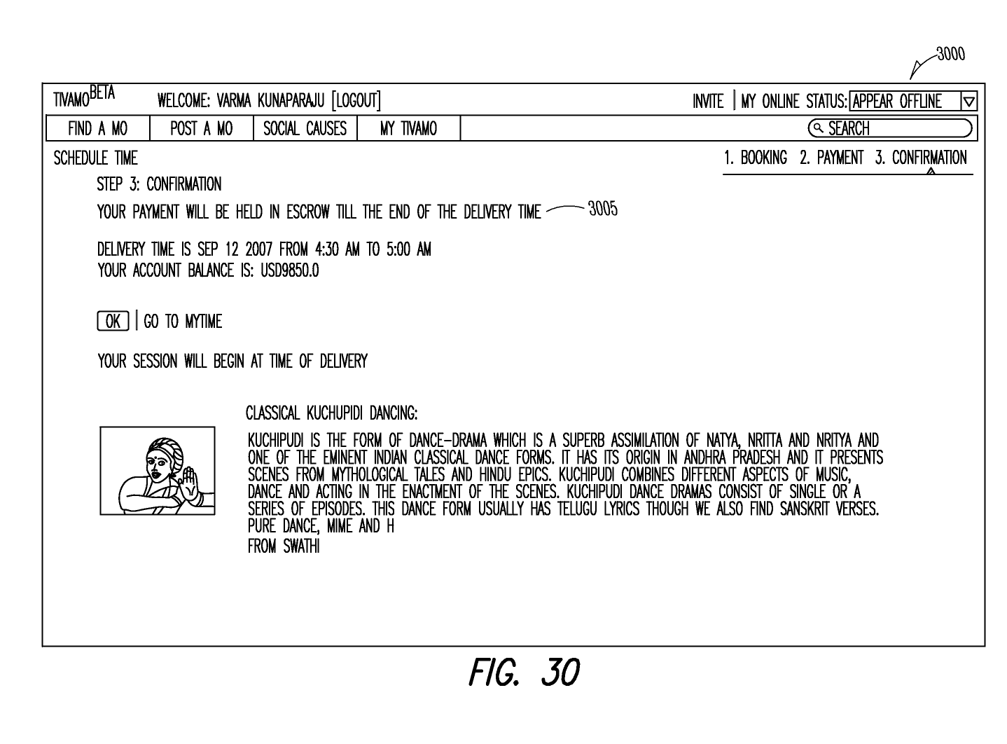

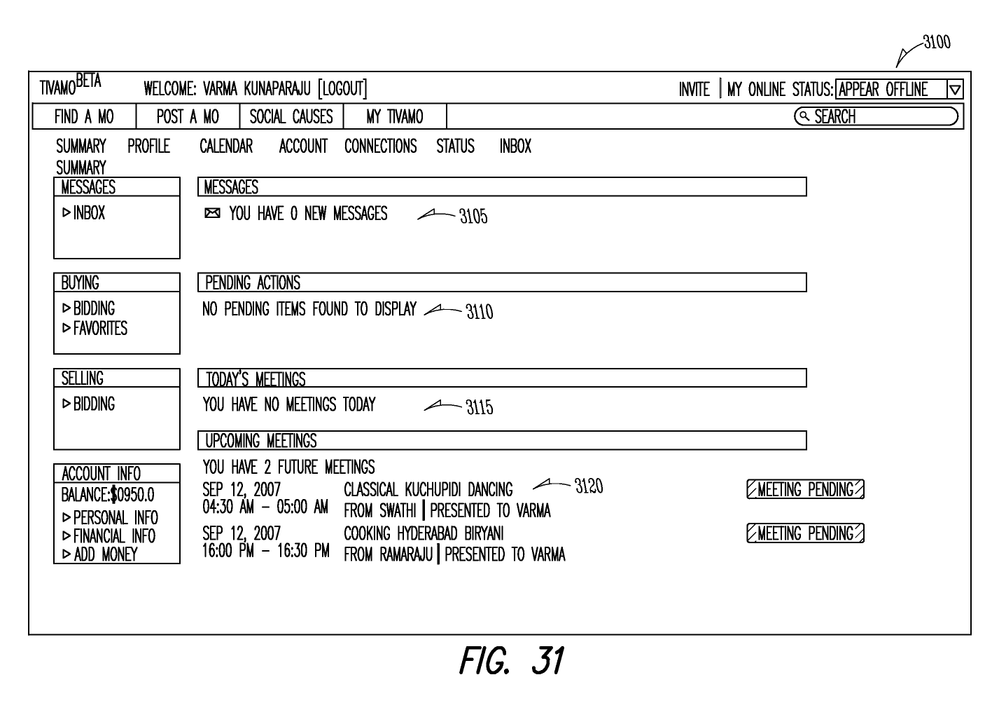

FIG. 30 illustrates an example of a confirmation interface 3000. The confirmation interface 3000 may include information about the time slot and about the resource. The confirmation interface 3000 may also indicate that the payment is held in escrow until completion of delivery of the related resource, as illustrated in message 3005.

FIG. 31 illustrates an example of an account summary interface 3100. The account summary interface 3100 may be for a consumer to view information about resources that have been purchased. The account summary interface 3100 may also include an email message indicator 3105 to let the consumer know of any pending new messages, a pending action indicator 3110 to let the consumer know if there is any action that may require the attention of the consumer, and current day meeting indicator 3115, and upcoming meeting indicator 3120.

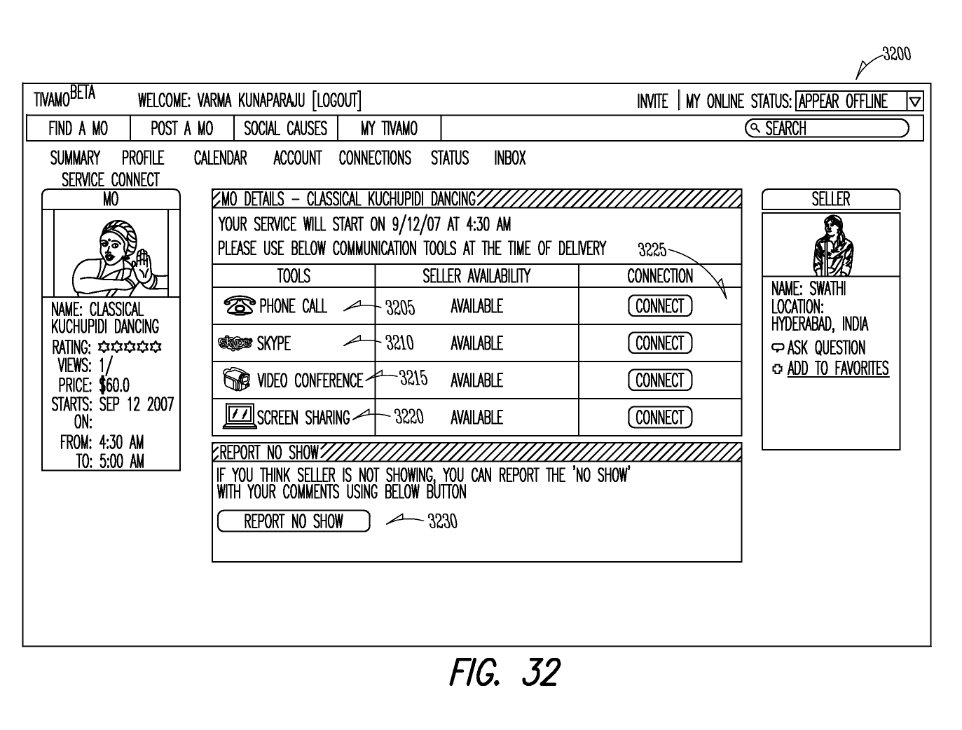

FIG. 32 illustrates an example of a communication tool interface 3200. The communication tool interface 3200 may displays communication options that the consumer may select so that the resource may be delivered. The resource may be delivered using telephone 3205, Skype™ VOIP communication 3210, video conference 3215 or screen sharing 3220. It may be noted that some of these communication techniques may not be available for some resources. Once a communication option is selected, the consumer may select the connect selector 3225 to connect to the seller/supplier. For some example embodiments, the communication tool interface 3200 may also include an option to report no show 3230. This may enable the consumer to let the matching system facilitator know that the delivery of the resource fail to take place, and the funds paid by the consumer may need to be kept in escrow and not paid out to the supplier/seller. It may be noted that some of the communication options may require the consumer to have sufficient equipments to enable the communication occur.

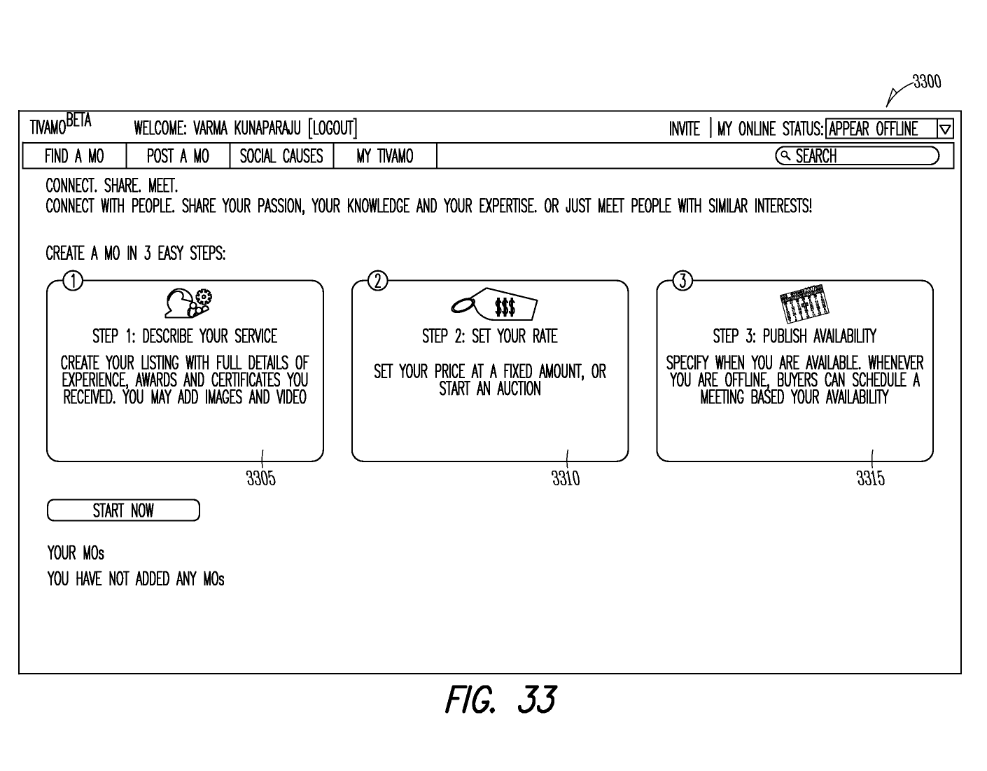

FIG. 33 illustrates an example of an interface that may be used to create a listing. Listing interface 3300 may enable a supplier/seller to list and to publish an available time-valued resource. The listing interface may display steps to create a listing (or MO). In this example, there is an indication that the creation of a MO involves three simple steps: describe your service 3305, set your rate 3310, and publish availability 3315.

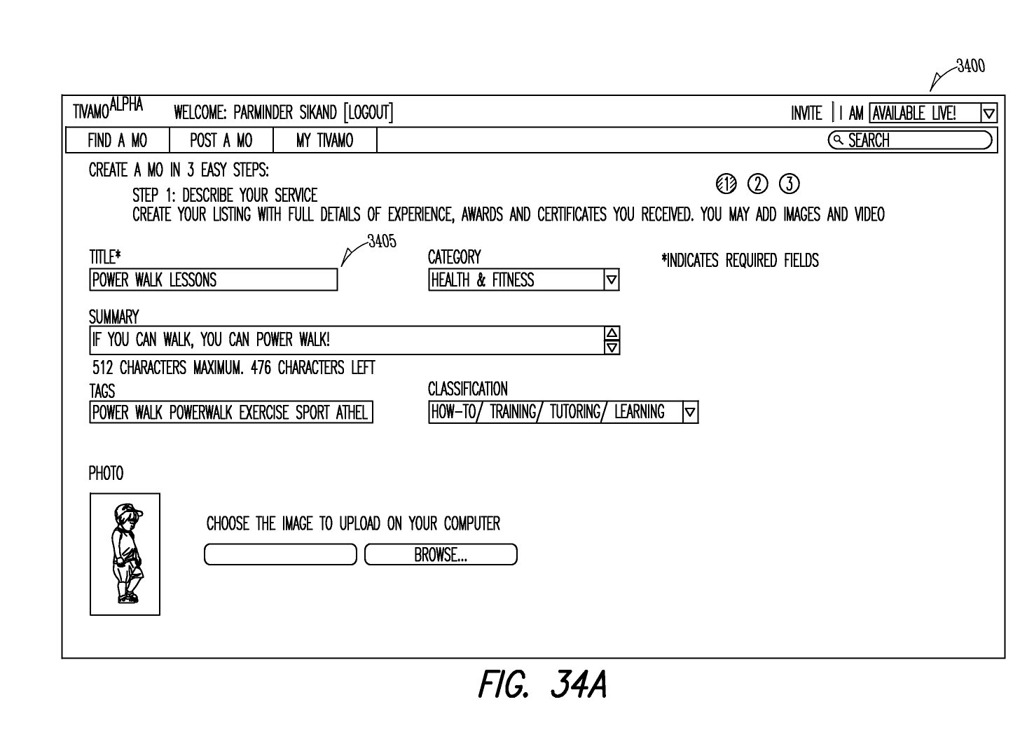

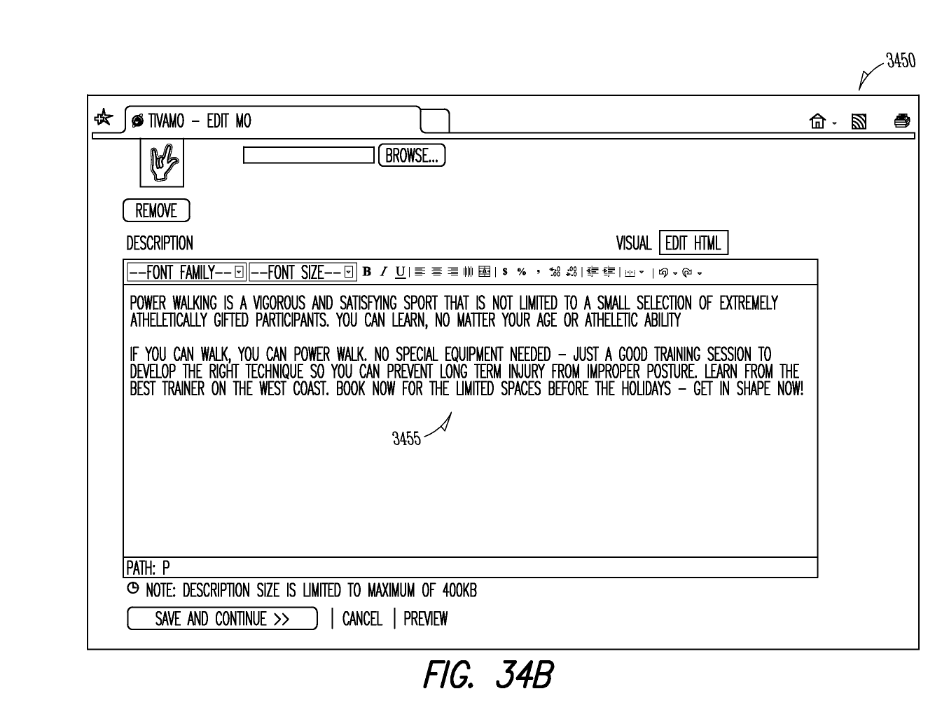

FIGS. 34A & 34B illustrates examples of an interface that may be used to describe a listing. Interface 3400 may include general description input area 3405 to allow a supplier/seller to provide the title, summary, tags, category, and classification information. Interface 3450 may include detailed description input area 3550 to provide further information about the resource/service. For some example embodiments, the supplier/seller may also include a brief video clip or audio clip to further describe the service. Other tools for marketing the service may also be available.

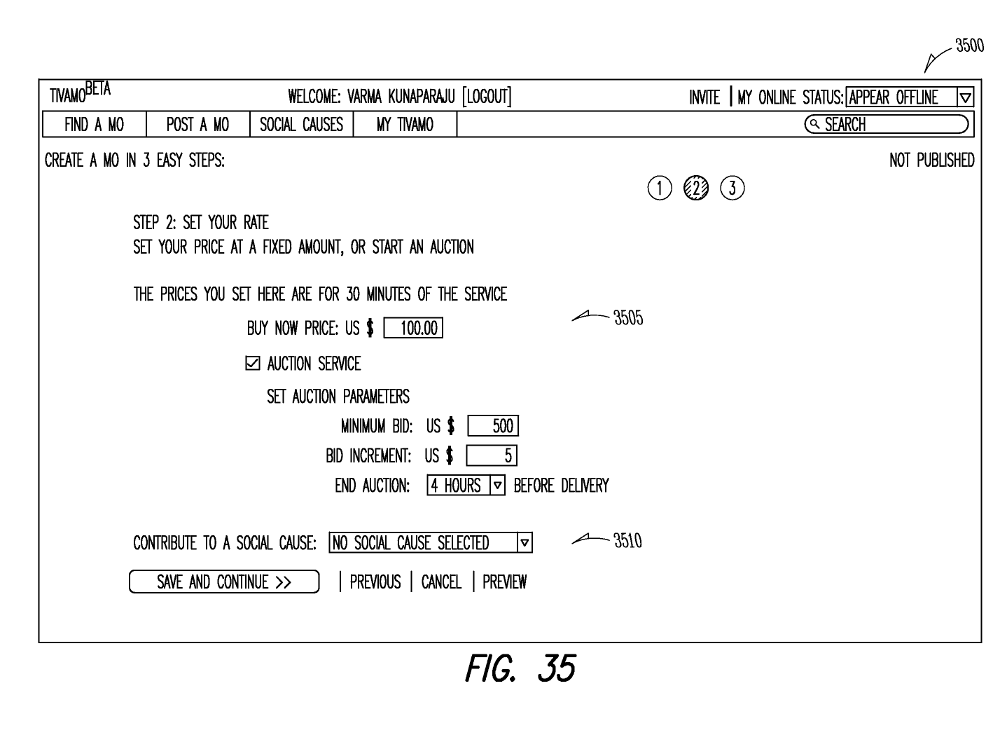

FIG. 35 illustrates an example of a rate interface 3500. The rate interface 3500 may include a rate detail area 3505 to enable the supplier/seller to set pricing information. The user may select either or both a “Buy now” price or an auction service with a minimum price, a price increment, and an end time for the auction. There is also a place for the user to select contribution to a social cause 3510 to which a donation may be made.

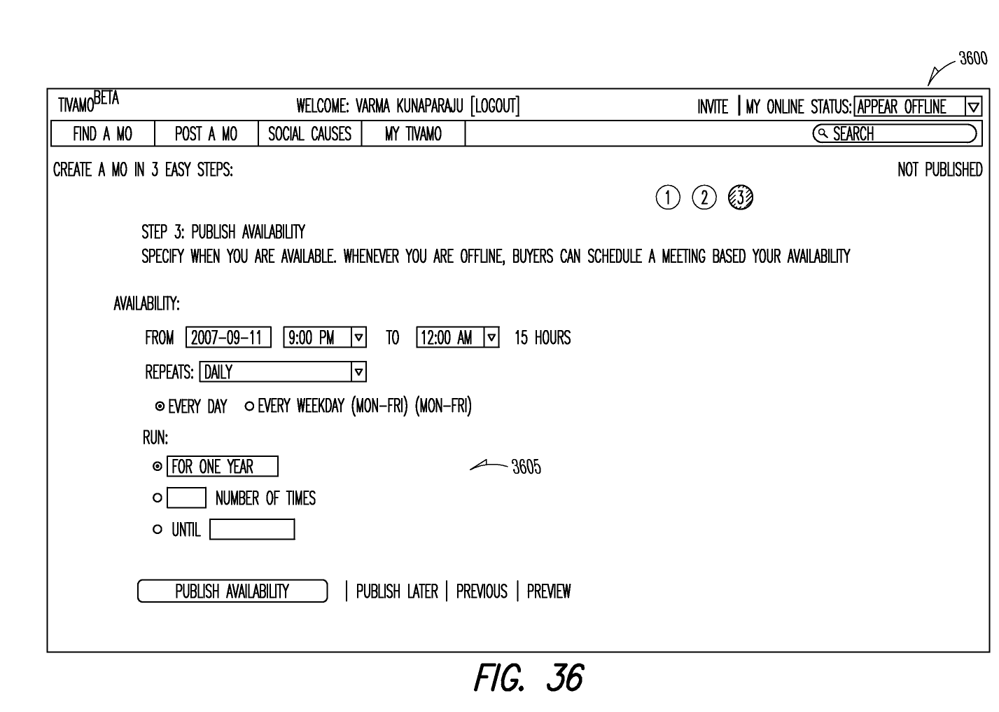

FIG. 36 illustrates an example of a publish interface 3600. The publish interface 3600 may enable a supplier/seller to publish a calendar of availability for the service/resource being listed. In this example, the supplier/seller may use the publish detail area 3605 to specify the dates and times, a recurrence method, and a condition of ending the listing. It may be noted that the publish interface 3600 may include an option to enable specifying how long the listing is to run for, an option to enable the listing to be delayed so that it can be published later, etc.

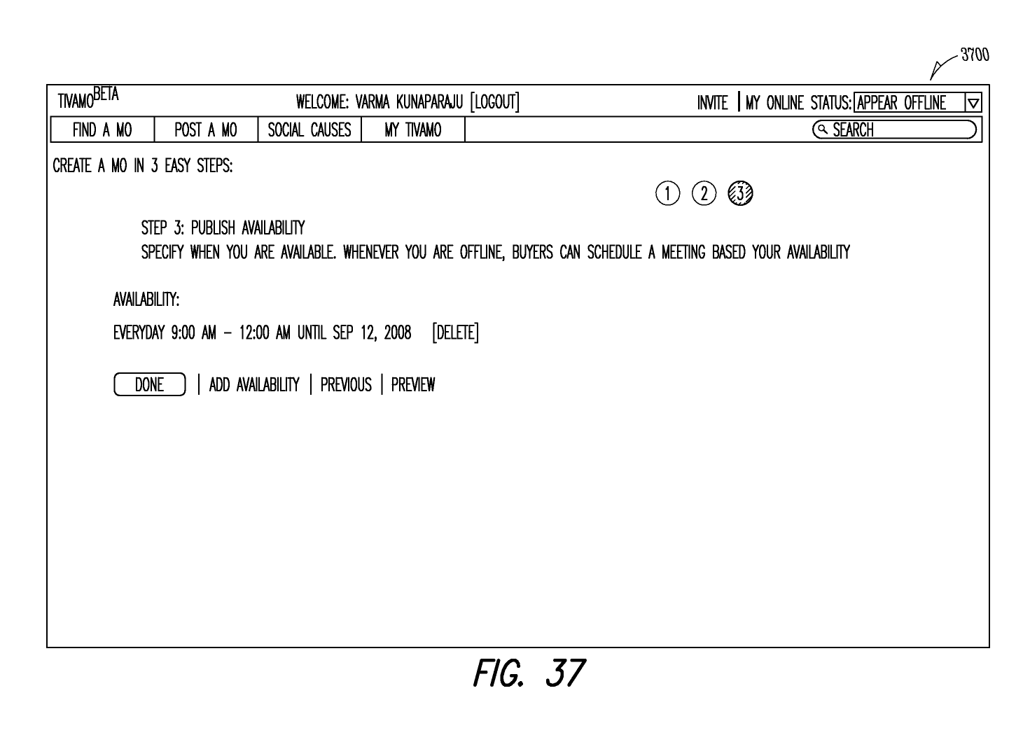

FIG. 37 illustrates an interface that enables listing information to be reviewed and confirmed. The listing may be confirmed, and it may become an official published listing. Alternatively, the listing or the availability information may be edited or deleted.

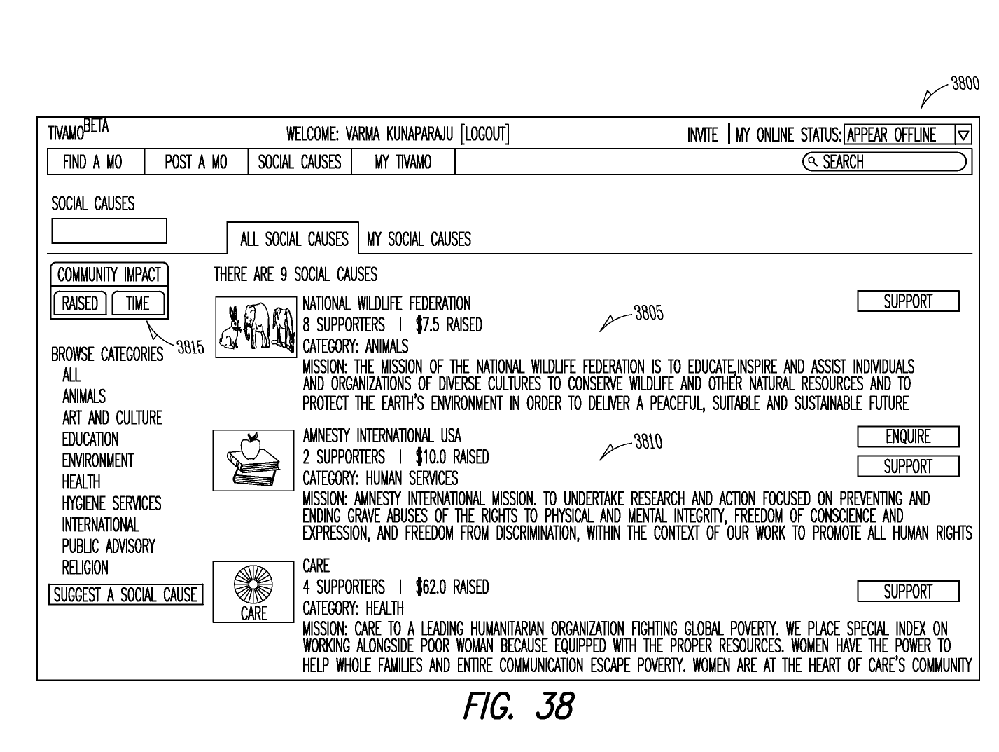

FIG. 38 illustrates an example of a social cause interface 3800. The social cause interface 3800 may displays information about social causes that have been entered into the matching system. The social cause interface 3800 may display detailed information about each social cause in the social cause description area 3805. A supplier or a consumer may learn more about each social cause, donate to a social cause, or invite others to be aware of the social cause using an appropriate selector in the selector area 3810. Other selectors may also be included in the selector area 3810. The social cause interface 3800 may display include a social cause status area 3815 to display the total amount of money raised, the amount of time that has been donated, etc. A user may also suggest or nominate additional social causes.

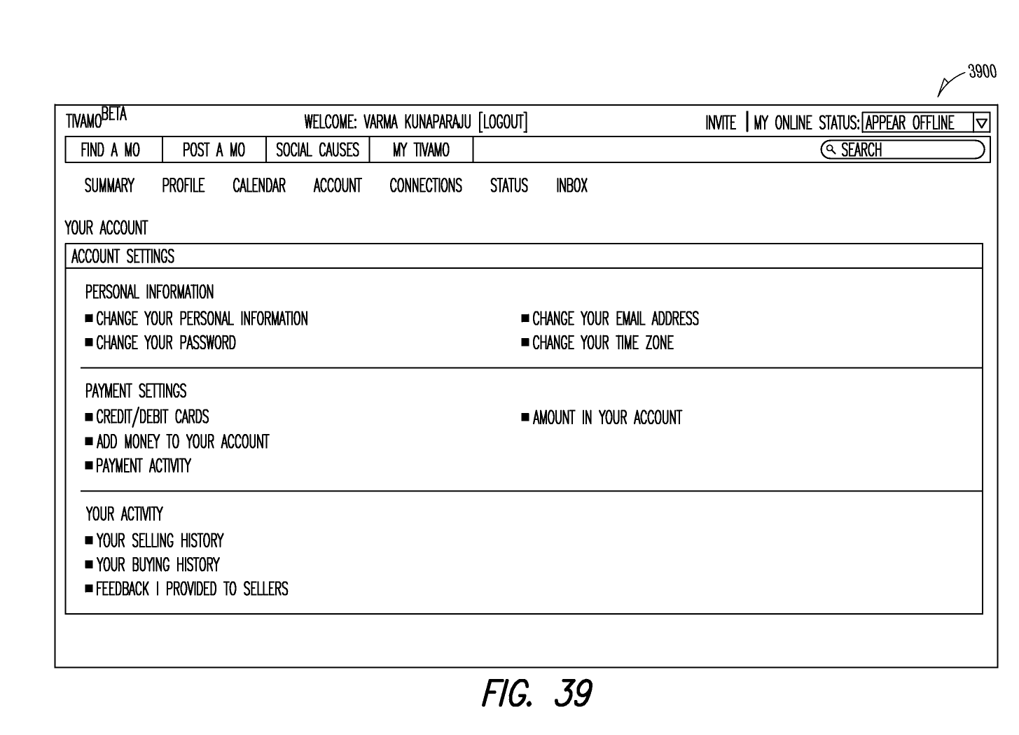

FIG. 39 illustrates an example of status interface 3900. The status interface 3900 may displays profile and other information associated with an account. There may be elements that may be specified or modified including, passwords, contact information, and payment methods. Other elements include the ability to review past activity, or feedback ratings.

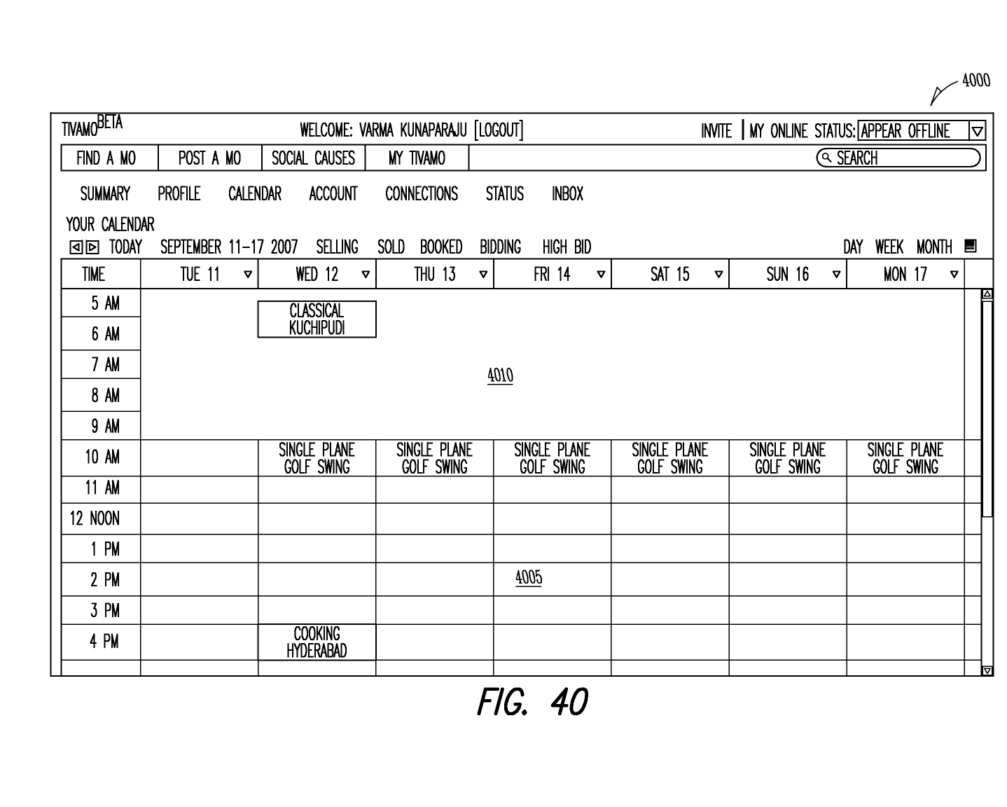

FIG. 40 illustrates an example of a calendar 4000. In this example, the calendar 400 may display items that are bought and is also some services that are being offered. Note that the calendar may integrate services bought with services offered to provide a complete view and to avoid conflicting times. For example, the bought service blocks out the relevant the calendar area 4005 to prevent offering services during that time slot. The offered services may only occupy the time slots in another calendar area 4010.

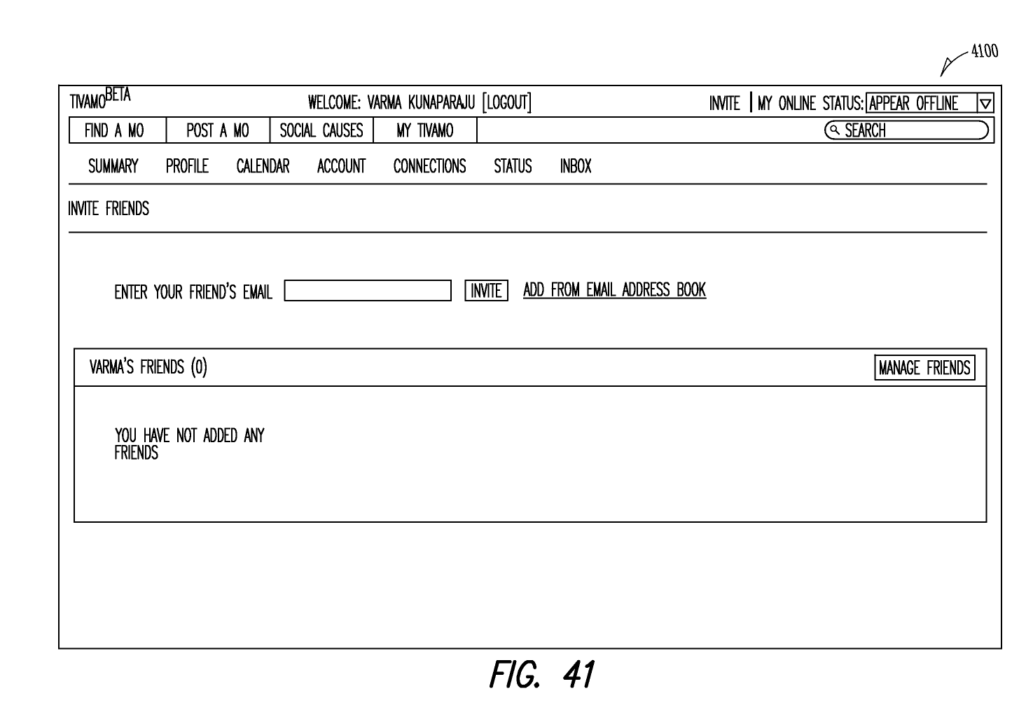

FIG. 41 illustrates an interface that may be used to invite friends or anyone else to become a member of the matching system. This may be used to have friends joining a group to form circle of friends. The group may then use its collective strength to form panels for needs or to form panels to offer resources at competitive pricing.

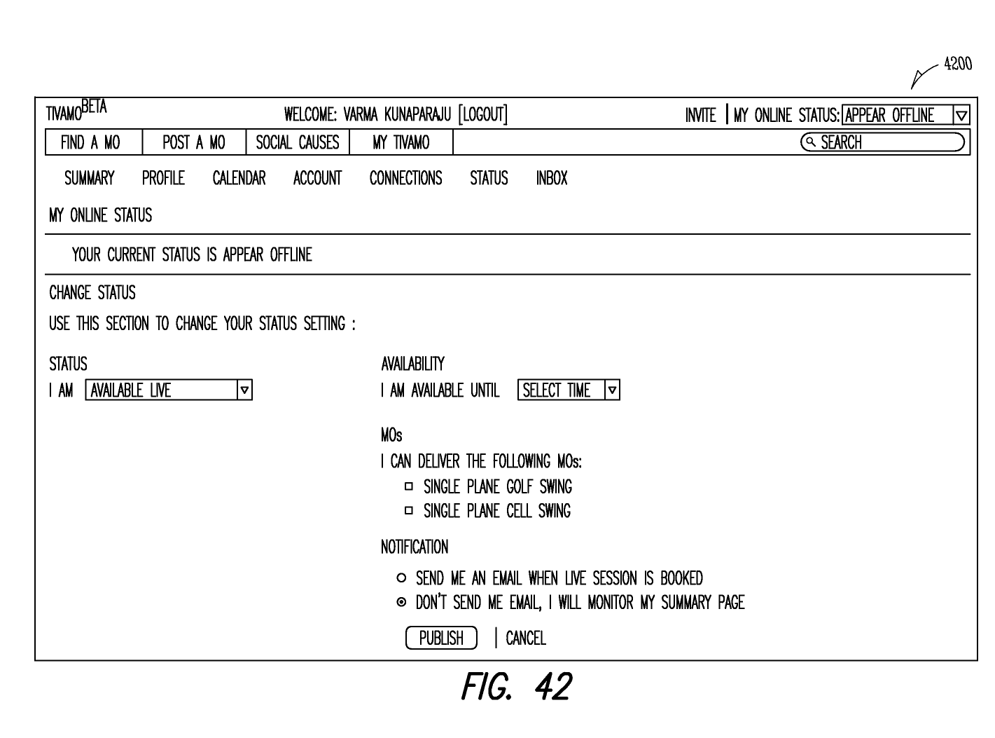

FIG. 42 illustrates an example of an online status interface 4200 that may enable a user to modify online status information. In the event the user does not want to be disturbed, the user may choose to appear offline or invisible to other users. In the event the user is available and appears online to other users, they may actually be contracted into a service that is currently being offered by them. This may represent a live purchase of a service, and would be delivered online following the necessary purchase steps by the buyer.

### XXXI/ Human Capital Avatar

Every human in the world has a variety of skills/experience in a given area. These skills may be broadly categorized as assets for monetization purposes. Human skills may generally get capitalized during normal business days by contributing to a given work environment. At the same time, there are a number of other skills each human possesses that may not get monetized. These skills do not get monetized because either there is no system in place that allows the human to recognize the value of these skills, or there is no method to render these skills to others who may need them.

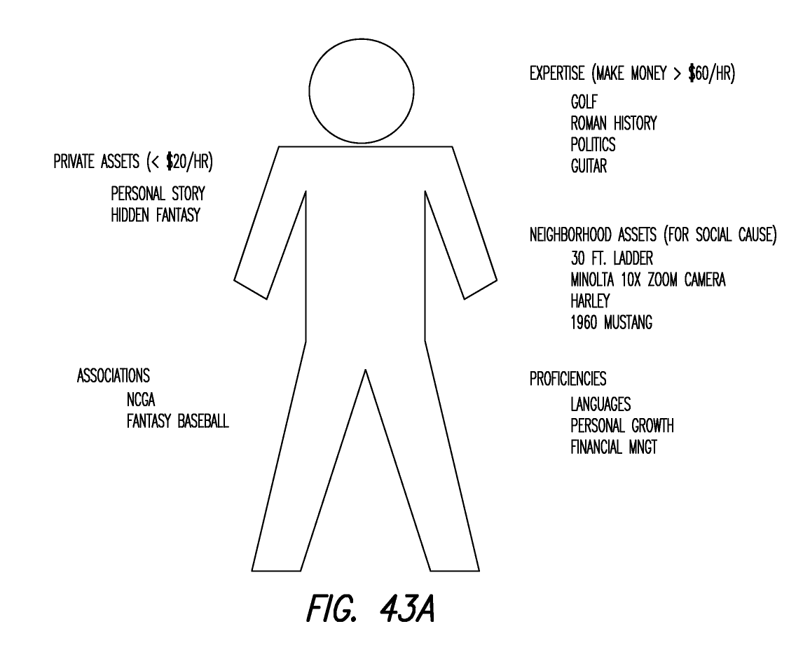

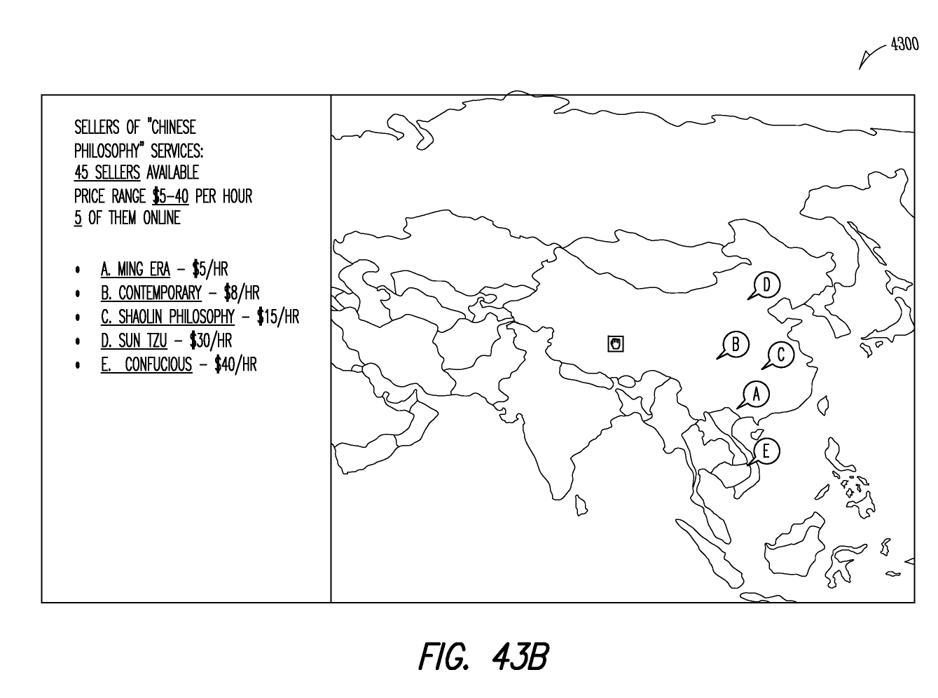

FIG. 43A illustrates an example diagram of an avatar, in accordance with some example embodiments. The avatar may be a graphical avatar (e.g., a photograph or other suitable image). Each human may be associated with an avatar. Each avatar may be marked with a set of skills that the associated human possesses. For some example embodiments, the skills of an avatar may be represented in graphical representation.

Using the current monetization value obtained from the market place, each skill may be used to compute the value for hourly/monthly/weekly or any other period of time. The monetization value may be determined by taking the given human's time and/or calendar availability into consideration. For example, a soccer coach may be busy and may not have any available time on weekends. However, the same coach might have a lot of other skills that can be monetized during the weekdays.

For some example embodiments, an avatar may be used to represent the values of these skills in a graphical representation taking into consideration the calendar of availability associated with the human supplier. The calendar of availability may either be entered by the human or may be obtained from the marketplace based on current market value or based on previous transactions associated with the human avatar.

For some example embodiments, there may be a representation of a users' nets asset value in a human capital avatar. In the case where the user is a human, then the representation may be of the human's capital or net asset value. When the user is an entity, the same principal may apply but may represent the entity capital or net asset value. These representations may take the form of a graphical depiction of the user in some form, such as an avatar or other image. This graphical presentation may include representation of the net assets of that user in a graphical form with one or more resources clearly marked and showing its current value by using the statistics of current market value of that skill. The representation of net asset value may be presented in various views, where the view can be adjusted to gain better understanding of the element being depicted, and may include options such as view the user, view a skill, etc.

XXXII/ Human Capital Avatar with Future Value

For some example embodiments, using a human capital avatar may motivate each user to represent their skills in the marketplace and to achieve monetization. The human avatar may enable the user to project their future value and allow them to play with possible scenarios of skills adjustment. It may allow the user to make better choices to achieve the desired balance of satisfaction and future value.

For some example embodiments, the matching system may be configured to compute the future value of a given user using the human capital avatar based on the current value for these skills and calculate a potential future value of these skills during the lifetime of the human, or some other extended time period.

For some example embodiments the user may have the option to modify value associated with the human avatar. For example, the values may include present value, projected increase or decrease in value, value with addition of other resources (skills), value with modification to current resources, etc. In such an embodiment, the user may be able to use tools to identify an alternate set of circumstances that may facilitate the potential change that is desired. Such a tool may allow the user to act by modifying the set of resources. For example, a tennis coach may be able to identify that an increase in the value of his tennis lessons is achievable by earning a certification from the USTA (or other such body). The coach may act on this information by earning such a certificate and adding the certification to the attributes and description of the tennis lesson resource listing.

### XXXIII/ Price/Visual Surfing

FIG. 43B illustrates an example of price surfing, in accordance with some example embodiments. For some embodiment, the matching system may be configured to provide an interface to enable the consumers and the suppliers to visually compare prices for time-valued resources worldwide. The interface may include an online map such as, for example, online map 4300 to enable visual surfing. The online map 4300 may be configured to allow a user to interact with the use of a cursor. For example, a consumer may use the online map 4300 to virtually travel or surf the globe looking for something interesting to engage with. This surfing may be at a global level (ATLAS) or special interest malls per individual account profile or general malls with random promotions.

As illustrated, a user may visit different regions and be able to view the marketplace according to the user's interest. For some example embodiments, the matching system may be implemented as a mall where the user may surf a map of the mall to view the resources offered by mall participants (or suppliers). Pricing information may be displayed. Advertising information associated with the mall may be displayed next to the online map to promote new items or to promote mall participants.

### XXXIV/ Computer Readable Media

Example embodiments may be provided as a computer program product that may include a machine-readable medium having stored thereon instructions, which may be used to program a computer (or other electronic devices) to perform methods described herein. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, example embodiments may also be downloaded as a computer program product, wherein the program may be transferred from a remote computer to a requesting computer by way of data signals embodied in a carrier wave or other propagation medium via a communication link (e.g., a modem or network connection).

### XXXV/ Example Computer System

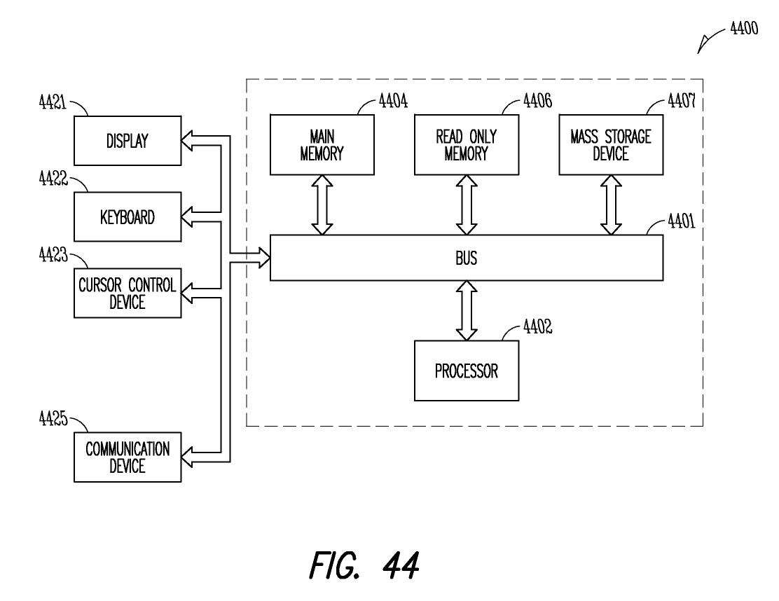

FIG. 44 is an example of a typical computer system upon which embodiments may be practiced. In the various embodiments, computer system 4400 may be utilized as a server on which information including matching information associated with the suppliers and the consumers may be stored. Furthermore, computer system 4400 may be used to enable the consumers and the suppliers to utilize their time-valued resources. The computer system 4400 may also be implemented as a server computer system.

Computer system 4400 comprises a bus or other communication means 4401 for communicating information, and a processing means such as processor 4402 coupled with bus 4401 for processing information. Computer system 4400 further comprises a random access memory (RAM), flash memory, or other dynamic storage device 4404 (referred to as main memory), coupled to bus 4401 for storing information and instructions to be executed by processor 4402. Main memory 4404 also may be used for storing temporary variables or other intermediate information during execution of instructions by processor 4402. Computer system 4400 may also comprise a read-only memory (ROM) and/or other static storage device 4406 coupled to bus 4401 for storing static information and instructions for processor 4402. A data storage device 4407 such as a magnetic disk or optical disk and its corresponding drive may also be coupled to computer system 4400 for storing information and instructions. In some architecture, a single memory device may perform the functions of two or more of the ROM 4406, the main memory 4404, and the mass storage device 4407. In other architectures such as might be implemented with a server, the system 4400 might have multiple mass storage devices 4407.

Computer system 4400 can also be coupled via bus 4401 to a display device 4421 such as a cathode ray tube (CRT) or Liquid Crystal Display (LCD), for displaying information to an end user. Typically, an alphanumeric input device 4422, including alphanumeric and other keys, may be coupled to bus 4401 for communicating information and/or command selections to processor 4402. Another type of user input device that may be included in the computer system 4400 is a cursor control 4423, such as a mouse, a trackball, a pen in conjunction with a touch sensitive screen, or cursor direction keys for communicating direction information and command selections to processor 4402 and for controlling cursor movement on display 4421.

A communication device 4425 may also be coupled to bus 4401. The communication device 4425 may include a modem, a network interface card or other well-known interface devices, such as those used for coupling to Ethernet, token ring, or other types of physical attachment for purposes of providing a communication link to support a local or wide-area network. In this manner, the computer system 4400 may be coupled to a number of clients and/or servers via a conventional network infrastructure, such as the Internet.

It may be noted that a lesser or more equipped computer system than the example described above may be desirable for certain implementations. Therefore, the configuration of computer system 4400 will vary from implementation to implementation depending upon numerous factors, such as price constraints, performance requirements, technological improvements, and/or other circumstances.

It may be noted that while the operations described herein may be performed under the control of a programmed processor such as processor 4402, in alternative embodiments, the operations may be fully or partially implemented by any programmable or hard-coded logic, such as Field Programmable Gate Arrays (FPGAs), TTL logic, or Application Specific Integrated Circuits (ASICs). Additionally, the method may be performed by any combination of programmed general-purpose computer components and/or custom hardware components. Therefore, nothing disclosed herein should be construed as limiting to a particular example embodiment wherein the recited operations are performed by a specific combination of hardware components.

The above description of illustrated example embodiments, including what is described in the abstract, is not intended to be exhaustive or to be limitation to the precise forms disclosed. The example embodiments described herein for illustrative purposes, various equivalent modifications are possible, as those skilled in the relevant art will recognize. For example, the matching system may enable the consumers and/or the suppliers to search its databases for time-valued resources because the matching system is a time/calendar aware system, and that the matching system may satisfy utilization of the time-based resources whether it is for the suppliers or for the consumers, and whether there is monetary payment by the consumers.

These modifications can be made to example embodiments in light of the above detailed description. The terms used in the following claims should not be construed to limit the disclosure to the example embodiments described herein. Rather, the scope is to be determined entirely by the following claims, which are to be construed in accordance with established doctrines of claim interpretation.

We claim:

1. A method of utilizing time-valued resources, the method comprising:
providing a first interface to enable one or more suppliers to publish listings of
available time-valued resources, wherein each of the available time-valued
resources is associated with a predetermined time slot of availability;
providing a second interface to enable one or more consumers to publish listings of
needed time-valued resources, wherein each of the needed time-valued
resources is associated with a predetermined time slot of need, wherein the first
interface and the second interface are provided by a matching engine; and
generating a notification when it is determined that a listing of an available time-valued
resource matches with a listing of a needed time valued resource based on time
information and calendar information.

2. The method of claim 1, further comprising enabling the one or more suppliers and the one or more consumers to provide attribute information and calendar information associated with the available time-valued resources and with the needed time-valued resources, respectively.

3. The method of claim 1, wherein the matching engine is to determine matches based on auction or fixed prices.

4. The method of claim 3, wherein the notification is sent to a supplier and a consumer associated with a match.

5. The method of claim 4, further comprising managing an agreement formed between the supplier and the consumer associated with the match.

6. The method of claim 5, wherein managing the agreement comprises managing payment associated with the agreement.

7. The method of claim 5, wherein managing the agreement comprises managing dispute resolution associated with the agreement.

8. The method of claim 1, wherein the matching engine is to enable one or more suppliers to enter into agreements with one or more consumers.

9. The method of claim 1, wherein the matching engine is to enable the one or more suppliers to promote the available time-valued resources to the one or more consumers.

10. The method of claim 9, wherein the matching engine is to enable the one or more suppliers to form panels of available time-valued resources to promote to the one or more consumers.

11. The method of claim 1, wherein the matching engine is to enable the one or more consumers to promote the needed time-valued resources to the one or more suppliers.

12. The method of claim 11, wherein the matching engine is to enable the one or more consumers to form panels of needed time-valued resources to promote to the one or more suppliers.

13. The method of claim 1, wherein the matching engine is to enable the one or more consumers to promote their needs to one or more suppliers.

14. The method of claim 1, further comprising enabling the one or more suppliers and the one or more consumers to donate to social causes to promote their rankings as related to the matching engine.

15. The method of claim 1, wherein the matching engine is to suggest promotion actions to the one or more consumers or to the one or more suppliers.

16. The method of claim 1, wherein the matching engine is to promote cross selling among the one or more consumers and the one or more suppliers.

17. The method of claim 1, wherein the matching engine is to enable the one or more suppliers to restrict association with a group of predetermined consumers.

18. The method of claim 1, wherein the matching engine is to enable the one or more consumers to restrict association with a group of predetermined suppliers.

19. The method of claim 1, wherein the matching engine is to promote the one or more consumers and the one or more suppliers based on a set of criteria.

20. The method of claim 19, wherein the set of criteria comprises one or more of confidence level, social cause donation level, service level, activity level.

21. The method of claim 1, wherein a time-valued resource associated with a supplier or a consumer is temporal.

22. The method of claim 21, wherein utilization of a time-valued resource comprises renting the time-valued resource.
